(19) United States
(12) Patent Application Publication
(10) Pub. No.: US 2013/0047978 A1
(43) Pub. Date: Feb. 28, 2013

(54) VORTEX-INDUCED CLEANING OF SURFACES

(71) Applicants: Alexander H. Slocum, Bow, NH (US); Bahaa I. Kazem, Baghdad (IQ); Stacy Figueredo, Oberkochen (DE)

(72) Inventors: Alexander H. Slocum, Bow, NH (US); Bahaa I. Kazem, Baghdad (IQ); Stacy Figueredo, Oberkochen (DE)

(73) Assignee: Massachusetts Institute of Technology, Cambridge, MA (US)

(21) Appl. No.: 13/222,547

(22) Filed: Aug. 31, 2011

(51) Int. Cl. F24J 2/12; B08B 7/00

(52) U.S. Cl. 126/694; 134/34

(57) ABSTRACT

A solar panel configured to reduce contaminant accumulation thereon, including a surface adapted to harvest solar energy; and a vortex-inducing generator including chevron-shaped features disposed across at least a portion of the surface to reduce contaminant accumulation thereon by causing air flow passing over the surface to remove at least some contaminants deposited thereon and/or keeping particles entrained in the air flow to reduce deposition on the surface. A method of passively cleaning a solar panel includes providing the solar panel, and positioning the solar panel such that the leading edge is oriented to intercept a prevailing wind direction. A solar array includes a plurality of the solar panels, wherein each solar panel is positioned such that the leading edge is oriented to intercept a prevailing wind direction.

### FIELD OF THE INVENTION

The present application relates generally to solar power systems. In particular, the present application relates to a solar power system that uses features on the edges of panels to induce vortices to help prevent airborne dust from depositing on the active solar power harvesting surfaces by keeping it airborne in swirling vortices and to help shake and blow off dust that may have accumulated when the air was still. The system may use large panels to receive solar energy, and is preferably kept clean to maintain efficient operation.

No federal funds were used in the development of this invention

### BACKGROUND

A solar concentrating system focuses the sun's energy to heat a working fluid steam for use in a conventional system cycle plant to produce electricity. Typically, parabolic reflectors to focus sunlight are located on an absorber tube at the focal point. Over a period of time, dust settles out of the atmosphere and deposits on the reflector surface, resulting in degradation of the performance of the solar concentrating system.

Solar energy collection systems need to remain free from dirt and obstructions to maintain their efficiency. Cleaning is therefore an important issue for solar power and plants, particularly if they are situated in inaccessible locations or when dust is an issue and where large quantities of clean water are hard to obtain, a situation that is characteristic of deserts. A need exists for low-cost, passive, and reliable methods to reduce dust accumulation on reflecting mirror surfaces and to reduce the high maintenance cost of solar power plants.

Dust removal methods may be classified into five categories:
1) Natural (wind lift, wind-induced vibration)
2) Mechanical (cleaning tools, cleaning robot systems)
3) Electromechanical (shaking by sound).
4) Electrical (electrostatic and electrodynamics)
5) Physical-chemical (self cleaning materials)

For machines on the planet Mars, the only significant category of natural dust removal is wind clearing. Wind clearing does not seem likely to be applicable for horizontal arrays at locations with wind conditions similar to those found at the Viking landing sites. See Geoffrey A. Landis. “Mars Dust-Removal Technology” J. Propulsion and Power. Vol. 14, No. 1, January-February 1998, incorporated herein by reference. Other sites may have periodic winds that are higher (although it should be noted that selecting a site for high winds will probably be contraindicated for other reasons).

The removal by wind of deposited dust was studied under Mars conditions by Gaier et al. See James R. Gaier et al., “Aeolian Removal of Dust from Photovoltaic Surfaces on Mars,” NASA Technical Memorandum 102507, February 1990, incorporated herein by reference. The low atmospheric pressure on Mars means that a higher wind velocity (compared to terrestrial conditions) is required for dust to be removed from a surface by wind clearing. The experiments of Gaier et al. show that a wind velocity of at least 35 m/s was required before significant amounts of dust removal was achieved by wind.

It is possible that by simply choosing an array orientation other than horizontal, dust will not effectively stick to the array. As the dust settles, there will be microscopic wind motions and, if the array is tilted, the bias effect caused by gravity may mean that the dust will move down the array, and thus not effectively stick. For example, dust did not accumulate on the vertically oriented camera window of Viking, and thus one can expect that by using a vertically oriented solar array, dust obscuration may be avoided.

A possible dust-removal strategy may use an articulated array that is periodically rotated into a vertical orientation for dust removal. This may be done with the motors used to deploy the array or by the tracking system, for an array incorporating solar tracking. It is unlikely that reorientation alone will be effective enough to remove adhered dust, because the adhesion forces of the dust are expected to be significantly higher than gravitational forces, but in a vertical position, one can expect that wind will cause the array to shake. This may cause adhered dust to be vibrated loose and removed. This removal strategy may be used during morning or afternoon periods when the sunlight is horizontal, or during the night, when array orientation is irrelevant.

Even for a horizontal array, such as the Surveyor Lander, wind-induced shaking of the array may result in dust removal. This will depend on the stiffness of the array, the natural frequency, and the interaction of the array with the wind. It may be desirable to deliberately design an array with an easily excited natural vibration frequency that may cause dust to be removed.

Mechanical dust removal includes physically clearing the surface using mechanical wiping, blowing, or removable covers. Dry mechanical wiping may be accomplished by astronauts using a tool designed for the task, effectively a broom or feather duster to break the dust adhesion. The dust adhesion is likely to be high enough and the particles small enough that a simple windshield wiper will probably not be effective. For an unmanned probe, a mechanical tool in the form of a mechanical arm with a rotating whisk on the end may be designed, but such a tool may be heavy and unreliable. See Landis.

According to Landis, a lubricated windshield wiper or cloth may be preferable. This is the system used on Earth in automobile windshield washers and for cleaning building windows. Designing such a system may involve investigating fluids that remain liquid at the cold Martian temperature and low atmospheric pressure. If such fluids cannot be easily replaced with in-situ resources, the cleaning fluid may have to be brought from Earth. Water may be extracted from the atmosphere, for example, by the operation of a sorption pump, and if the array is warm enough, this may be a possibility.

Some processes proposed for the production of rocket fuel on Mars involve the capture of water from the atmosphere or out of permafrost; if such a system is used, a small amount of the water may be available for use as a cleaning agent. Because the ambient atmospheric pressure of Mars is low enough that liquid water is not present in an equilibrium state, use of water as a cleaning agent would have to be done quickly.

The Viking Lander included a system where a compressed jet of gas may be directed to the window. Such a system may be designed with either a canister of gas brought from Earth, with a gas reservoir refilled from a compressor operating on the ambient atmosphere, or with a set of fans. Jets of atmosphere may be designed to locally exceed the 35 m/s velocity. See Landis.

Finally, for the case where the effect of a single dust event (or a small number of dust events) is to be mitigated, it may be possible to use a simple transparent cover over the array, which may be removed and discarded after the dust event. The cover may be a simple sheet of a thin plastic such as Mylar. This might be a reasonable approach, for example, if a lander is to be designed to survive a single Mars year, and the deposition of one global dust storm is to be accounted for. If a plastic is chosen for this use, it will be necessary to qualify the material for operation under the combined uv, radiation, and chemical conditions of Mars to verify that it will not degrade in either mechanical or optical properties. See Landis.

Recently, there have been much demand for automatic cleaning system on outside surfaces of buildings such as window glass, as there has been an increase in modern architecture. Some customized window cleaning machines have already been installed into practical use in the field of building maintenance. A robotic dust wiper technology is designed to clean surfaces of optical UV from deposited Martina dust particles. This device may have further cleaning applications (solar panels, sensors, cameras, windshields etc), and particular it may be useful whenever a robust mechanism is needed, that is required to operate in human hostile conditions. See Luis Mareno, et al., “Low Mass Dust Wiper Technology for MSL Rover,”. Proceedings of the 9^{th} ESA Workshop on Advanced Space Technologies for Robotics and Automation, Noordwijk, the Netherlands, Nov. 28-30, 2006, incorporated herein by reference.

The following examples provide an overview of a wide variety of designs for facade cleaning robots.

A robot for vertical façades “SIRIUSc” is a walking robot for automatic cleaning of tall buildings and skyscrapers. The robot can be used on the majority of vertical and steeply inclined structure surfaces and facades. See Norbert Elkman et al., “Innovative Service Robot Systems for Façade Cleaning of Difficult-to-Access Areas,” Proceedings of 2002 IEEE/RSJ Intl. Conference on Intelligent Robots and Systems, Switzerland; October 2002, incorporated herein by reference.

The façade cleaning robot for vaulted facades shown at the Leipzig 1997 Trade Fair is the first façade cleaning robot for vaulted buildings world wide. Because of the building's unique architecture, the robot is very specialized system and is not modularly designed like the SIRIUSc. Several types of façade cleaning robots have been developed for different applications in Europe and Japan. See E. Gambao et al., “Control System for a Semi-automatic Façade Cleaning Robot,” ISARC2006, incorporated herein by reference.

A balloon-based cleaning robot has been developed to use for cleaning the inner site of atriums and glass roofs. See Norbert Elkmann et al., “Innovative Service Robot Systems for Façade Cleaning of Difficult-to-Access Areas,” Proceedings of Intelligent Robots and Systems IEEE/RSJ International Conference Vol. 1 (2002) pages 756-762 In most cases, large, clumsy gantries are necessary to guarantee access for cleaning staff or climbers who are hired at great cost to clean the glass.

A Sky Walker is a new kind of glass wall cleaning robot totally actuated by pneumatic cylinders. It is portable, dexterous enough to adapt to the various geometries of a wall, and intelligent enough to autonomously detect and cross obstacles. See Zhang et al., “Realization of a Service Climbing Robot for Glass-wall Cleaning,” Proceedings of the 2004 IEEE, International Conference on Robotics and Biomimetics, Aug. 22-26, 2004, Shenyang, China, incorporated herein by reference. A testing simulation shows that the robot can cross an obstacle safely and reliably when it moves from one column glass to another in the right-left direction; the reference gives a summary of the main special features of the cleaning robot.

However, almost of these robots are mounted on the building from the beginning and are expensive. Therefore, requirements for small, lightweight and portable window cleaning robots are also growing in the field of building maintenance. As the result of surveying the requirements for a window cleaning robot, the following points are identified as necessary for providing the window cleaning robot for practical use:
1) It should be small size and lightweight for portability.
2) It should be able to clean the corners of windows because fouling is often left there.
3) It should sweep the windowpane continuously to prevent making a striped pattern on a windowpane.
4) It should have automatic operation while moving on the window.
   See Miyake et al., “Development Of Small-Size Window Cleaning Robot By Wall Climbing Mechanism,” ISARC2006, incorporated herein by reference.

The locomotion mechanism is preferably chosen to satisfy these demands. A number of different kinds of kinematics for motion and cleaning (locomotion) on smooth vertical surfaces have been presented over the past decade. A small-size window cleaning robot had been developed for indoor window cleaning application. See Miyake et al.

Electromechanical methods include shaking the array, shocking the array, or using sound or ultrasound to break dust adhesion. These are similar to the natural removal techniques discussed earlier. They may require either wind or tilting the array to carry the dust away after adhesion is broken.

A vibration characterization control can be used effectively for self cleaning solar panels using piezoceramic actuation by creating best dust cleaning motion. See R. Brett Williams, et al., “Vibration Characterization of Self-Cleaning Solar Panels With Piezoceramic Actuation,” AIAA, 2007, incorporated herein by reference.

It was noted that higher frequency excitations tend to remove the dust more efficiently, so subsequent tests were conducted from 400 to 5000 Hz. Expanded bandwidth testing showed that higher responses were present above 2000 Hz. High frequency results also indicated that traveling waves are excited, which may explain the increased dust removal under such excitation conditions.

The simplest of the electrical removal methods is electrostatic removal. If the array surface is charged, the array will attract particles of opposite or neutral charge and repel particles of the same charge. If the surface is conductive enough to be able to transfer charge to the particles on contact, any dust particle in electrical contact with the surface will accumulate a charge the same as that of the array, and thus be repelled from the array. The dust particles may then be removed either by wind, tilting the array, or by providing a sink of opposite charge for them to be attracted to. The array may be charged by incorporating a transparent conductor on the surface and temporarily charging the array with a high-voltage supply. An alternative is to use an ion- or electron-beam or a radioactive source to charge the surface remotely, if this can be done at the atmospheric pressures to be encountered. Yet another alternative may be to use the photoelectric effect to charge the surface, possibly incorporating a material that will charge in the natural solar UV environment.

An alternative solution is to use electrostatic forces to not allow the dust to deposit in the first place. If Mars dust particles have a natural charge, for example, induced by photoelectric effect, this may be done by simply placing a like charge on the array. However, because charging of either polarity will attract neutral particles (by induced-dipole attraction), this is not likely to be a solution. A charged body near, but not on, the array might be used to attract particles away from the array. Electrostatic forces may also be used to create an atmospheric flow over the array. Finally, an electrostatic discharge (glow discharge, Paschen discharge) may be created over the array. This may result in dust removal by charging the dust or even, conceivably, by glow discharge cleaning. See Landis.

An electrodynamic screen was designed, built, and tested for the removal of particles from its surface. The technology has a large number of applications ranging from space exploration to biotechnology. The electrodynamic dust shield is used to remove dust from surfaces using electrodes that alternately connected to an AC source and ground. The electrodes are embedded in a transparent dielectric film to decrease break down potential. See A. S. Biris, et al., “Electrodynamic Removal of Contaminant Particles and Its Applications” 2004 IEEE, incorporated herein by reference.

Also, special efforts to use electrostatic and dielectrophoretic forces to develop a dust removal technology that prevents the accumulation of dust on solar panels and removes dust adhering to those surfaces. Testing of several prototypes showed solar shield output above 90% of the initial potentials after dust clearing. Multi-phase electric curtains generate traveling-waves that can lift and convey charged particles have been proposed. See C. I. Calle, et al., “Particle Removal by Electrostatic and Dielectrophoretic Forces for Dust Control During Lunar Exploration Mission,” J Electrostatics, 2009 and Pierre Atten et al., “Study of Dust Removal by Standing Wave Electric Curtain for Application to Solar Cells on Mars,” 334-340 Vol. 1, IAS 2005, both references incorporated herein by reference.

A number of technical innovations are becoming available that provide materials and surfaces with self cleaning capabilities, relying on altering properties of film to either (i) increase the adherence of water (superhydrophylic surfaces), including catalysts that break down organic debris under influence of sunlight or (ii) decrease the adherence of water (superhydrophilic surfaces) resulting in water forming non-adherent round droplets on the surface that remove dirt and debris as they run off the surface. Both methods need a water source, either naturally or by using sprinklers. See www.microsharp.co.uk/solar/Innovation in Solar Concentration, incorporated herein by reference.

As the need for solar power increases while costs are expected to decrease, efficiency needs to increase. This means the working temperature are preferably increased and losses decreased. This has not been achieved in the past, and indeed, system complexity seems to have increased with increasing temperatures. There is a need for a system that overcomes the limitations of high temperature and complexity.

### SUMMARY

Particle concentrations of only 6 g/m² of mirror can cause up to 85% loss in reflectivity, which directly affects the overall efficiency of a solar collector module. Accordingly, reduction of particles is an important factor for increasing the efficiency of solar collector modules.

Embodiments of the invention include a low cost, passive, and reliable solar power surface, such as a parabolic trough panel, with design embedded features to reduce dust accumulation and assist in cleaning the reflecting mirror surfaces. The cleaning strategy is a combination of a natural direct cleaning method employing wind effect and wind vortex induced cleaning. Modifying the aerodynamic properties of a surface by adding geometrical features may help to control air flow velocity across a panel surface and to create flows on the panel surface with high kinetic energy.

In some embodiments of this invention, features in or on surfaces that reflect or collect solar energy induce vortices when there is an appropriate airspeed and angle of attack. The induced vortices may provide air flow that keeps dust particles airborne, thus preventing the dust particles form settling on active solar surfaces. The induced vortices may induce vibrations in the surfaces to help shake free dust that has settled on the solar surfaces during periods of still air. The induced vortices may provide air flow that keeps dust particles airborne so it does not settle on active solar surfaces. The induced vortices may also provide air flow that entrains and removes dust that has settled on the solar surfaces during periods of still air. Protruding features or sawtooth features along the edges of the surfaces may induce the vortices. Hole-like features may be provided along the edges of the surfaces to induce the vortices; the holes may also be used to drain contaminants.

Embodiments of the invention may include a solar power system with features on the edges of panels that induce vortices to help prevent airborne dust from depositing on the active solar power harvesting surfaces by keeping it airborne in swirling vortices. Vibrations may be induced in the surfaces to help shake free and blow off dust that may have accumulated when the air was still. The solar power system may include low cost, passive and reliable solar power surface, such as a parabolic trough panel, with design embedded features to reduce dust accumulation and assist in cleaning the reflecting mirror surfaces. The cleaning strategy may be a combination of natural direct cleaning by wind effect and cleaning by wind-induced vortices. Modifying the aerodynamic properties of a surface by adding geometrical features helps control the air flow velocity across the panel surface and at the same time controls the frequency and amplitudes to create flows on the panel surface with high kinetic energy. These new design features may reduce the maintenance cost of solar power plants.

In one aspect, embodiments of the invention include a solar panel configured to reduce contaminant accumulation thereon. The solar panel includes a surface adapted to harvest solar energy, and a vortex-inducing generator that includes a plurality of chevron-shaped features disposed across at least a portion of the surface to reduce contaminant accumulation thereon by at least one of (i) causing air flow passing over the surface to remove at least some contaminants deposited thereon; and (ii) keeping particles entrained in the air flow to reduce deposition on the surface.

One or more of the following features may be included. The surface may include a parabolic-shaped trough. The vortex-inducing generator may include a UV-resistant polymer, metal, glass, and/or a composite. At least one chevron-shaped feature may define an included angle selected from a range of about 30 degrees to about 120 degrees. At least one chevron-shaped feature may define an opening having a maximum width equal to a, and the chevron-shaped features are disposed on the solar panel surface at a pitch selected from a range of about 1.5a to about 5a. At least one chevron-shaped feature may define an opening having a maximum width equal to a, and a maximum height of 2a.

At least one chevron-shaped feature may include a constant height. At least one chevron-shaped feature may include a varying linear height. At least one chevron-shaped feature may include a varying nonlinear height. Each chevron-shaped feature may form a gap with the surface along at least a portion thereof. Each chevron-shaped feature may be oriented at an angle selected from a range of ±45° relative to an edge of the surface. The surface may define a plurality of openings. The solar panel may include a supporting structure for the surface.

In another aspect, embodiments of the invention include a method of passively cleaning a solar panel. The method includes providing the solar panel. The solar panel includes a surface adapted to redirect solar energy, and a vortex-inducing generator that includes a plurality of chevron-shaped features disposed across at least a portion of the surface proximate a leading edge to reduce contaminant accumulation thereon by at least one of (i) causing air flow passing over the surface to remove at least some contaminants deposited thereon; and (ii) keeping particles entrained in the air flow to reduce deposition on the surface, The solar panel is configured such that the leading edge is oriented to intercept a prevailing wind direction.

One or more of the following features may be included. The positioning step may include measuring at least one of a wind velocity and a vibration of the panel, and actuating a panel positioning system to position the panel to a previously known best position for a given wind velocity. A supporting structure may be provided for the surface. The supporting structure may be adapted to move the surface. The surface may be moved to track the solar energy and/or intercept a changed wind direction.

In yet another aspect, embodiments of the invention include a solar array having a plurality of solar panels. Each solar panel includes a surface adapted to redirect solar energy, and a vortex-inducing generator that includes a plurality of chevron-shaped features disposed across at least a portion of the surface proximate the leading edge, wherein the vortex-inducing generator is configured to reduce contaminant accumulation thereon by at least one of (i) causing air flow passing over the surface to remove at least some contaminants deposited thereon; and (ii) keeping particles entrained in the air flow to reduce deposition on the surface. Each solar panel is positioned such that the leading edge is oriented to intercept a prevailing wind direction.

### BRIEF DESCRIPTION OF DRAWINGS

Embodiments of the present invention may best be understood in conjunction with the accompanying drawings, in which:

FIG. 1 is a schematic diagram showing an isometric view of a parabolic trough with vibration-inducing features along its edges;

FIG. 2 is a graph showing threshold velocities for different dust particle diameters;

FIG. 3 is a graph showing fluid and impact threshold levels;

FIG. 4 is a schematic diagram showing forces on a particle near the vortex;

FIG. 5 is a table showing effects of vortex generator shape on pressure & velocity;

FIG. 6 is a schematic diagram showing two opposite rotation vortices generated downstream after each vortex generator;

FIG. 7a is a schematic diagram showing test configuration for vortex generator shapes;

FIGS. 7b and 7c are schematic diagrams showing vortex generator effects on air velocity (front and top view) for two different vortex generators;

FIG. 8 are schematic diagrams showing pressure and velocity distributions around the tip of two different vortex generators;

FIG. 9a is a schematic diagram showing the flow pattern over a parabolic surface with vortex generators along its edge

FIG. 9b is a series of schematic diagrams showing flow stagnation inside the inner surface of the panel;

FIG. 10 includes two series of schematic diagrams showing the effect of adding circular holes with (a) illustrating velocity distributions for a panel without holes, and (b) illustrating velocity distributions for a panel with nine circular holes at center (R=1.5 cm); air velocity Vy=−2.5, Vz=4.33 m/s;

FIGS. 11a-11b includes two series of schematic diagrams showing the effect of adding holes with FIG. 11a illustrating velocity distributions for nine circular holes at center (1.5 cm) and twenty triangular holes at the edge (L=1.782 cm), and FIG. 11b illustrating velocity distributions for nine circular holes at center (R=1.5 cm) and nineteen circular holes at the edges; air velocity Vy=−2.5, Vz=4.33 m/s;

FIG. 12 is a graph illustrating the loading of a parabolic panel by the wind;

FIG. 13 is a series of schematic diagrams illustrating different vortex generators for a parabolic panel;

FIG. 14 includes two graphs illustrating the drag coefficient Cd for different pitch angles: (a) computational fluid dynamics (CFD) analysis, (b) experimental results for parabolic solar collector;

FIG. 15 includes two graphs illustrating the lift coefficient Cf for different pitch angles: (a) CFD analysis, (b) experimental results for a parabolic solar collector in accordance with an embodiment of the invention;

FIG. 16 is a graph illustrating flow parameters Cd for different design scenarios and pitch angles;

FIG. 17 is a graph illustrating flow parameters Cf for different design scenarios and pitch angles;

FIG. 18 is a graph illustrating maximum dynamic pressures for different design scenarios;

FIG. 19 is a graph illustrating maximum air velocities for different design scenarios;

FIG. 20 is a graph illustrating maximum shear forces on the surface for different design scenarios;

FIG. 21 is a graph illustrating maximum turbulent energy for different design scenarios;

FIG. 22 is a graph illustrating maximum turbulent energy on the surface for different design scenarios on surface 1;

FIG. 23 is a graph illustrating flow parameters Cf for different design scenarios on surface 1;

FIG. 24 is a graph illustrating flow parameters Cd for different design scenarios on surface 1;

FIG. 25 is a graph illustrating average velocity for different design scenarios on surface 1;

FIG. 26 is a graph illustrating average dynamic pressures for design scenarios on surface 1;

FIG. 27 is a graph illustrating average values for TKE on surface 1;

FIG. 28 is a graph illustrating average values for GTKE on surface 1;

FIG. 29 is a graph illustrating average values for shear forces at surface 1;

FIG. 30 is a series of graphs illustrating different design parameters for different design scenarios;

FIG. 31 is a series of graphs illustrating the frequency spectrum for deferent design scenarios;

FIG. 32 is a series of graphs illustrating the frequency spectrum for wind drag forces at different wind speeds;

FIG. 33 is a schematic diagram showing the air velocity distributions around a panel for wind velocity 9 m/s and panel pitch angle 30 degrees;

FIGS. 34a-34b are a series of graphs illustrating nonlinear time dependent displacement, velocity and acceleration for panel scenarios A-S1 and B-S3;

FIG. 35 is a schematic diagram illustrating displacement fields due to wind load (force-moment system), (wind speed 7 m/s, panel pitch angle 60 degrees);

FIG. 36 is a schematic, isometric view of a parabolic trough with vortex generators along its edges, in accordance with an embodiment of the invention;

FIG. 37 is a schematic, isometric view of a vortex generator, in accordance with an embodiment of the invention;

FIG. 38 is a schematic, isometric view of a vortex generator, in accordance with an embodiment of the invention;

FIG. 39 is a test matrix depicting vortex generators and associated flow fields, in accordance with an embodiment of the invention;

FIG. 40 is a schematic, isometric view of a flow pattern in the vicinity of a vortex generator in air at 5 m/s, in accordance with an embodiment of the invention;

FIG. 41 is a schematic, front view of a flow pattern in the vicinity of a vortex generator in air at 5 m/s, in accordance with an embodiment of the invention;

FIG. 42 is a schematic, side view of a flow pattern in the vicinity of a vortex generator in air at 5 m/s, in accordance with an embodiment of the invention;

FIG. 43 is a schematic, front view of a flow pattern in the vicinity of a vortex generator in air at 5 m/s, in accordance with an embodiment of the invention;

FIG. 44 is a schematic, side view of a flow pattern in the vicinity of a vortex generator in air at 5 m/s, in accordance with an embodiment of the invention;

FIG. 45 is a photograph of PIV testing of vortex generator shapes in a water tunnel, in accordance with an embodiment of the invention;

FIG. 46 is a photograph of extruded vortex generator shapes for evaluating angular effects, in accordance with an embodiment of the invention;

FIG. 47 is a photograph of vortex generator cross-sections with 50 micron particles in a water tunnel, in accordance with an embodiment of the invention;

FIG. 48 is a vector field and velocity map for a 30 degree vortex generator, in accordance with an embodiment of the invention;

FIG. 49 is a vector field for 30 degree vortex generator cross-sections with 50 micron particles in a water tunnel, in accordance with an embodiment of the invention;

FIG. 50 is a vector field and velocity map for a 45 degree vortex generator, in accordance with an embodiment of the invention;

FIG. 51 is a vector field plot for a 45 degree vortex generator, in accordance with an embodiment of the invention;

FIG. 52 is a vector field and velocity map for a 60 degree vortex generator, in accordance with an embodiment of the invention;

FIG. 53 is a vector field plot for a 60 degree vortex generator, in accordance with an embodiment of the invention;

FIG. 54 is a photograph of a vortex generator on a mirror film surface with testing locations circled, in accordance with an embodiment of the invention;

FIG. 55 is a photograph of a vortex generator on a mirror film surface after 23 minutes of contamination in a dust chamber, in accordance with an embodiment of the invention;

FIG. 56 is a photograph of a vortex generator on a mirror film surface after 5.9 m/s air flow over the panel, in accordance with an embodiment of the invention;

FIG. 57 is a photograph of a mirror film surface after 23 minutes of contamination in a dust chamber with a previous vortex generator location shown, in accordance with an embodiment of the invention;

FIG. 58 is a photograph of a mirror film surface after 5.9 m/s air flow over the panel with no vortex generator, in accordance with an embodiment of the invention;

FIG. 59 is a plot of reflectance of a mirror film surface for the initial surface, the contaminated surface, the vortex generator cleaned surface, and the non-vortex generator cleaned surface, in accordance with an embodiment of the invention;

FIG. 60 is a plot of the efficiency of a mirror film surface for vortex generator cleaning compared to the non-vortex generator cleaned surface, in accordance with an embodiment of the invention;

FIG. 61 is a schematic, isometric view of a flow pattern in the vicinity of vortex generator shape 1 in air at 5 m/s, in accordance with an embodiment of the invention;

FIG. 62 is a schematic, front view of a flow pattern in the vicinity of vortex generator shape 1 in air at 5 m/s, in accordance with an embodiment of the invention;

FIG. 63 is a schematic, side view of a flow pattern in the vicinity of vortex generator shape 1 in air at 5 m/s, in accordance with an embodiment of the invention;

FIG. 64 is a schematic, isometric view of a flow pattern in the vicinity of vortex generator shape 2 in air at 5 m/s, in accordance with an embodiment of the invention;

FIG. 65 is a schematic, front view of a flow pattern in the vicinity of vortex generator shape 2 in air at 5 m/s, in accordance with an embodiment of the invention;

FIG. 66 is a schematic, side view of a flow pattern in the vicinity of vortex generator shape 2 in air at 5 m/s, in accordance with an embodiment of the invention;

FIG. 67 is a schematic, isometric view of a flow pattern in the vicinity of vortex generator shape 3 in air at 5 m/s, in accordance with an embodiment of the invention;

FIG. 68 is a schematic, front view of a flow pattern in the vicinity of vortex generator shape 3 in air at 5 m/s, in accordance with an embodiment of the invention;

FIG. 69 is a schematic, side view of a flow pattern in the vicinity of vortex generator shape 3 in air at 5 m/s, in accordance with an embodiment of the invention;

FIG. 70 is a schematic, isometric view of a flow pattern in the vicinity of vortex generator shape 4 in air at 5 m/s, in accordance with an embodiment of the invention;

FIG. 71 is a schematic, front view of a flow pattern in the vicinity of vortex generator shape 4 in air at 5 m/s, in accordance with an embodiment of the invention;

FIG. 72 is a schematic, side view of a flow pattern in the vicinity of vortex generator shape 4 in air at 5 m/s, in accordance with an embodiment of the invention;

FIG. 73 is a schematic, isometric view of a flow pattern in the vicinity of vortex generator shape 5 in air at 5 m/s, in accordance with an embodiment of the invention;

FIG. 74 is a schematic, front view of a flow pattern in the vicinity of vortex generator shape 5 in air at 5 m/s, in accordance with an embodiment of the invention;

FIG. 75 is a schematic, side view of a flow pattern in the vicinity of vortex generator shape 5 in air at 5 m/s, in accordance with an embodiment of the invention;

FIG. 76 is a schematic, isometric view of a flow pattern in the vicinity of vortex generator shape 6 in air at 5 m/s, in accordance with an embodiment of the invention;

FIG. 77 is a schematic, front view of a flow pattern in the vicinity of vortex generator shape 6 in air at 5 m/s, in accordance with an embodiment of the invention; and

FIG. 78 is a schematic, side view of a flow pattern in the vicinity of vortex generator shape 6 in air at 5 m/s, in accordance with an embodiment of the invention.

In the drawings, preferred embodiments of the invention are illustrated by way of example, it being expressly understood that the description and drawings are only for the purpose of illustration and preferred designs, and are not intended as a definition of the limits of the invention.

### DETAILED DESCRIPTION

Given the scarcity of water in dusty environments where solar thermal power is typically installed, cleaning of reflective mirror surfaces is an important issue. Traditional methods for cleaning parabolic trough collectors consist of manual washing using water. Systems of large brushes and water tanks as well as pressure washers on truck-beds are used by cleaning crews who periodically drive between rows of collectors to remove dust that has been deposited on the mirror surface, which requires 22 L/m²·year at sites in the southwest United States. See Sargent & Lundy LLC Consulting Group. Assessment of parabolic trough and power tower solar technology cost and performance forecasts, 2003. The costs of the water, which generally is not recovered, makes mirror cleaning an expensive task, and may be impractical in regions where clean water infrastructure does not exist. However, the loss in panel efficiency if the panel is not cleaned is an even larger cost in terms of overall energy costs. As an example of the order of magnitude of cleaning costs, equation 1 gives a cleaning water cost of $0.011/m² year if one assumes water is generated using desalination at a cost of $0.50/m³ of water. See Forbes, Energy recovery, 2008. http://www.forbes.com/technology/2008/05/08/mitra-energy-recovery-tech-science-cx_sm_{—}0509mitra.html.

$$[ \frac{22 L}{{m}^{2} year} ] [ \frac{0.001 {m}^{3}}{1 L} ] [ \frac{\$0 .50}{{m}^{3}} ] = \frac{\$0 .011}{{m}^{2} year} \qquad ( 1 )$$

In addition to the cost of water labor for a plant on the order of 100,000 m² of panels, assuming a cleaning crew of 3 working throughout the year at $30,000/year per person, and not including the cleaning equipment would result in a total plant cleaning cost of $91100/year or $0.91/m² year (Equation 2). See N. Hosoya et al., “Wind Tunnel Tests of Parabolic Trough Solar Collectors,”, National Renewable Energy Laboratory—USA, March 2001-August 2003, incorporated herein by reference.

$$[ \frac{\$0 .011}{{m}^{2} year} ] [ \frac{100 \text{,} 000 {m}^{2}}{plant} ] + [ \frac{3 personnel}{plant} ] [ \frac{\$30 \text{,} 000}{personnel \cdot year} ] = \frac{\$91 \text{,} 000}{year} \qquad ( 2 )$$

Comparing this cost to the cost of electricity generated per square meter, with an assumed cost of 0.20/kWe, equation 3 gives a generated panel value of $87/m² year. Overall the cost of manual cleaning with desalinated water is 1% of the generated electric value. Because dirt deposited on a panel can quickly result in an 85% reduction in reflective efficiency, meaning approximately $74/m² year difference in the generated electricity, the costs associated with cleaning are necessary. More effective cleaning methods, however; other methods for cleaning may be more effective overall. While the estimates here simplify the costs and efficiencies associated with such a system, they provide a first order comparison of cleaning costs and difference in performance for a panel if cleaned effectively.

$$[ \frac{6 kWh}{{m}^{2} day} ] [ \frac{365 day}{year} ] [ \frac{0.20 {efficiencykWh}_{e}}{{kWh}_{solar}} ] [ \frac{\$0 .20}{{kWh}_{e}} ] = \frac{\$87}{{m}^{2} year} \qquad ( 3 )$$

In addition to water use limitations, manual cleaning with brushes may load the edges of glass mirror panels causing breakage, resulting loss of efficiency, and expensive repairs. Finally, using brushes and water, which contains sand particles, may scratch the mirror surface, which is especially risky for mirror film applications and front side reflectors. Surface erosion may lead to losses in reflectivity in the same manner as a sand storm would.

Alternative cleaning methods may take advantage of mechanical, electrostatic, fluid and vibrational means of removing particles. A summary of potential methods, which is by no means exhaustive, is shown in Table 7.1. These methods are divided into active implementations, which require additional energy to interact with contaminants, and passive methods, which require no additional energy. For example, an active mechanical method may use a series of rollers to push particles off of the mirror surface, whereas a passive mechanical method may use the existing turning of the trough over the day, which is required anyway for operation, to dump particles by purely gravitational effect. Risks of mechanical methods are that the forces involved in moving the particles may be high enough to scratch the mirror surface or even break the mirror panel. Given the variety of strategies for cleaning mentioned, and the inherent efficiency loss of an active method that may add additional parasitic loads to the solar field, passive methods are preferable as the overall cleaning focus.

Electrostatic methods use ionizing particles or control of surface static charge to reduce the surface attraction of particles. An active method, such as an ionizing air knife, requires both forced air flow and a power source for the ionizing air. Ionizing air knives are often used in clean room applications where passive methods are not possible. A passive electrostatic method may use grounding of the surface to reduce surface charge, much in the way that electrostatic discharge is controlled in clean room environments. Another possible passive method is the use of antistatic materials and coating on the surface of the mirror; however, such a coating would have to be optically clear. In general, better materials for conductors or electrostatic dissipaters are opaque, making their effectiveness as a mirror coating unlikely.

Vibration of the panel structure, either actively with shaker motors or piezo actuators, or passively by tuning the structure to vibrate with wind loading effects, may remove larger particles. Because this method depends on inertial forces, the effectiveness largely depends on the particle size distribution and energy transfer to the particles and is often limited to outer contamination layers and particle larger than 100 microns. See William C. Hinds. Aerosol technology: properties, behavior, and measurement of airborne particles. Wiley, New York, 2nd edition, 1999.

Fluid methods, e.g., standard water cleaning process, use fluid flow to lift particles from the surface. Active methods preferably use air, other gases, or viscous gels that are forced over the surface. CO₂ snow cleaning, where fluid flow is coupled with nucleation of small dry ice particles to remove contamination by momentum transfer, is also possible, as is used for telescope optics. See R. Sherman, J. Grob, and W. Whitlock. Dry surface cleaning using CO₂ snow. Journal of Vacuum Science & Technology B, 9(4):1970-1977, July-August 1991, and R. Sherman. Carbon dioxide snow cleaning. Particulate Science and Technology, 25(1):37-57, January-February 2007, both incorporated herein by reference. Finally, a passive fluid flow method, where the wind that flows over the panel is used with turbulator tapes or vortex generators to create vortices, may be integrated into the current structure. Re-entrainment of particles for glass beads with varying bulk air velocities has been studied. See M. Corn and F. Stein. Re-entrainment of particles from a plane surface. American Industrial Hygiene Association Journal, 26(4):325-&, 1965, and William C. Hinds, Aerosol technology: properties, behavior, and measurement of airborne particles, Wiley, New York, 2^{nd} edition, 1999; both incorporated herein by reference. Use of vortex generators for surface cleaning may provide a novel means of minimizing contamination. In related areas such as photovoltaic panels, the need for surface cleaning measures has been suggested in solar power applications for autonomous vehicles in space. See G. A. Landis. Dust obscuration of mars solar arrays. Acta Astronautica, 38(11):885{891, June 1996, and G. A. Landis. Mars dust-removal technology. Journal of Propulsion and Power, 14(1):126{128, January-February 1998.

Given the initial background science of the passive methods discussed above, the passive fluid method using vortex generators may be especially preferable.

TABLE 7.1
Cleaning strategies based on mechanical, electrostatic, fluid
and vibrational methods with active and passive implementations.

| Method | Active | Passive |
|---|---|---|
| Mechanical | Brushes Rollers | Dumping during trough positioning |
| Electrostatic | Ionizing air knife | Ionizing bar (antistatic methods) |
| | | Grounding methods Antistatic |
| | | materials |
| Fluid | Air nozzle | Vortex generators/Turbulators |
| | Viscous/collectible | |
| | gels | |
| Vibration | Piezo-timed cleaning | Tuned panel structure |
| | Shaker motors | |

An especially preferred passive cleaning concept, as discussed below, is the use of vortex generators to increase turbulent flow over a mirror surface. Typically used to control flow over airplane wings, vortex generators placed on the edges of mirror panels may increase wind-induced vortices that prevent dust from settling on the surface and or that prevent re-entrainment of dust already deposited on the mirror surfaces. Using features such as vortex generators, small holes in the panel edges, or other raised features, minor changes to the panel may reduce the need for water-based cleaning technologies and may require little or no maintenance.

As used herein, a “vortex-inducing feature” denotes one or more chevron-shaped features that are configured to cause air flow passing over a solar panel surface to reduce contaminant accumulation thereon.

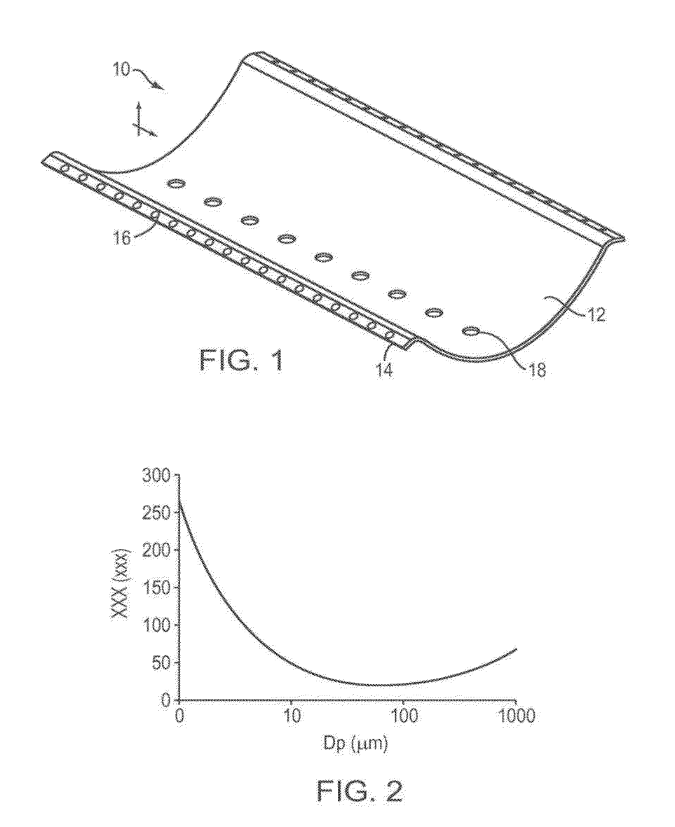

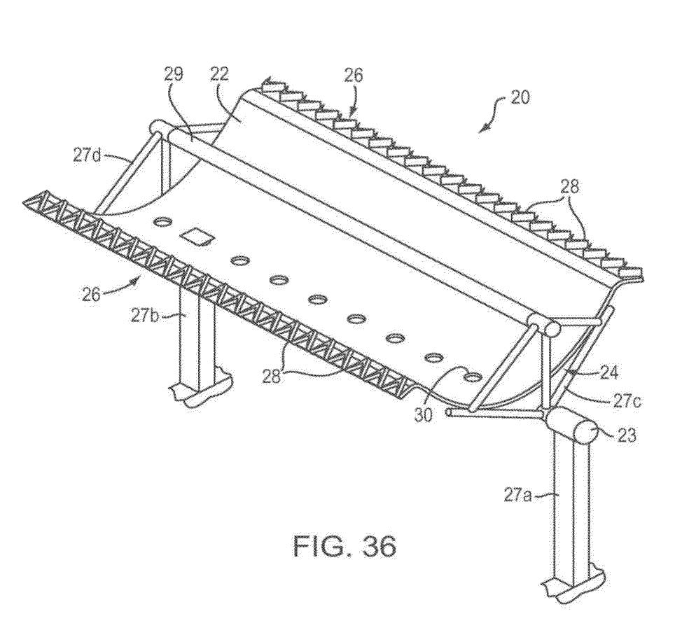

Some embodiments of the invention use wind-induced vibration to prevent dust build up and also to help remove dust that may accumulate during calm weather. First some concepts of fluid flow mechanics are presented. FIG. 1 shows an embodiment of the invention where a panel 10 has a main surface 12, such as for reflecting sunlight to a central receiving tube 29 (not shown in FIG. 1 but shown in FIG. 36), and flanges 14 with vortex-inducing holes 16. Protruding vortex-inducing features (discussed below) may also be used. Holes 18 in panel 10 help control pressure profiles and further enable contaminants dust/dirt to be disposed of by, e.g., allowing them to fall out the bottom of the surface.

From a physical point of view, the particle motion initiated by wind is controlled by the forces acting on the particles. For particles at rest, these forces are the weight, the inter particle cohesion forces, and the wind shear stress on the surface. See B. Martcorena, et al., “Modeling the atmospheric dust cycle:1. Design of a soil-derived dust emission scheme,” Journal of Geophysical research, Vol. 100, No. D8, pp 16,415-16,430. Aug. 20, 1995, incorporated herein by reference.

All together determine the minimum threshold friction velocity U*ₜ required to initiate particle motion, with the friction velocity being

$$\begin{matrix}{\overline{U}}^{*} = \sqrt{\overline{τ} / {ρ}_{a}} & ( 4 ) \\ \overline{τ} = {ρ}_{a} {C}_{D} U & ( 5 )\end{matrix}$$

Where ρₐ, U, C_{D} is density, velocity of air and drag coefficient, respectively, for a particle.

Generally there are three major types of grain motion classified in relation to the size of the particles.
1—The finest particles (<60 μm), or desert dust, are small enough to be transported upwards by turbulent eddies (suspension movement).
2—The soil grains in the range of 60 to 2000 μm may be lifted from a surface to a height of several tenths of a centimeter, then back to the surface (saltation movement).
3—The particles too large or too heavy to be lifted from the surface (>2000 μm) roll and creep along the surface (creeping movement)
   See B. Martcorena et al. The threshold friction velocity U*ₜ is calculated as follows:

$${U}_{t}^{*} = A ( \frac{{ρ}_{p} {gD}_{p}}{{ρ}_{a}} ) \qquad ( 6 )$$

Where g is the gravitational acceleration; ρₚ is particle density; Dₚ is particle diameter and ρₐ is air density (in terrestrial conditions ρₐ=0.00123 g cm⁻³; ρₚ=−2.65 gcm⁻³)
A is called the dimensionless threshold and is expected to depend on the friction Reynolds number B which is defined at erosion threshold as follows:

$$B = \frac{{U}_{t}^{*} {D}_{p}}{υ} \qquad ( 7 )$$

With ν=the kinematic viscosity of the air. An approximate expression for U*ₜ versus Dₚ was then fitted by matching the Reynolds number in the following form:

B=aDₚ^{X}+b (8)

Where a=13311, b=0.38, and x=1.56. With respect to the dimensionless Reynolds number, a has a unit of cm^{-x}. For 0.03<B<10

$${U}_{t}^{*} ( {D}_{p} ) = \frac{0.129 K}{{( 1.928 {( {aD}_{p}^{x} + b )}^{0.092} - 1 )}^{0.5}} \qquad ( 9 )$$

### For B>10

U*ₜ(Dₚ)=0.129K[1−0.0858exp(1−0.0617(aDₚ^{x}+b)−10))] (10)

The relation between U*ₜ and Dₚ is plotted in FIG. 2. See B. Martcorena et al.

### Turbulence and Aeolian Sand Transport

The relationship between wind velocity and sand transport is commonly parameterized by the friction velocity, the threshold friction velocity, air density, and grain parameters. Bagnold (1941) showed that there are two thresholds for saltation: the fluid threshold, which is defined as the speed at which particles start moving due to the forces of wind only, and the impact threshold, which is the speed at which the combined action of wind forces and saltation impacts can just sustain movement, or alternatively, the speed at which the energy received by the average saltating grains becomes equal to that lost (by impact) so that motion is sustained. These two threshold wind speeds differ by 20% and are determined in nature by analysis of gust intervals where the wind speed rises and the saltation begins, and lull intervals with decreasing winds and stopping saltation. See H. J. Schonfeldt, “Turbulence and Aeolian sand transport,” Apr. 16, 2008, EGU Vienna, 2008 incorporated herein by reference.

Vf is the fluid threshold, which is defined as the speed at which particles start moving due to the forces of wind only, and Vi is the impact threshold, which is the speed at which the combined action of wind forces and saltation impacts can just sustain movement.

Scaled impact threshold velocity is defined as follows. The impact threshold is zero point eight of the fluid threshold and therefore the saltation scaled fluid threshold is one point twenty five. See H. J. Schonfeldt.

The saltation scaled velocity is:

$$V = \frac{U ( z )}{{U}_{i} ( z )}$$

$${V}_{i} = \frac{{U}_{i}^{*}}{{U}_{i}^{*}} = 1$$

$$Vf = \frac{{U}_{f}^{*}}{{U}_{i}^{*}} = 1.25$$

The sand transport may be determined using synthetic time series constructed by a first order autoregressive Markov process. See H. J. Schonfeldt. These time series are not only characterized by the mean wind speed but also by the turbulence parameter c (c=standard deviation of the wind speed related to the mean wind speed) and the autocorrelation r (r=the autocorrelation of the wind with a time-shift of one second).

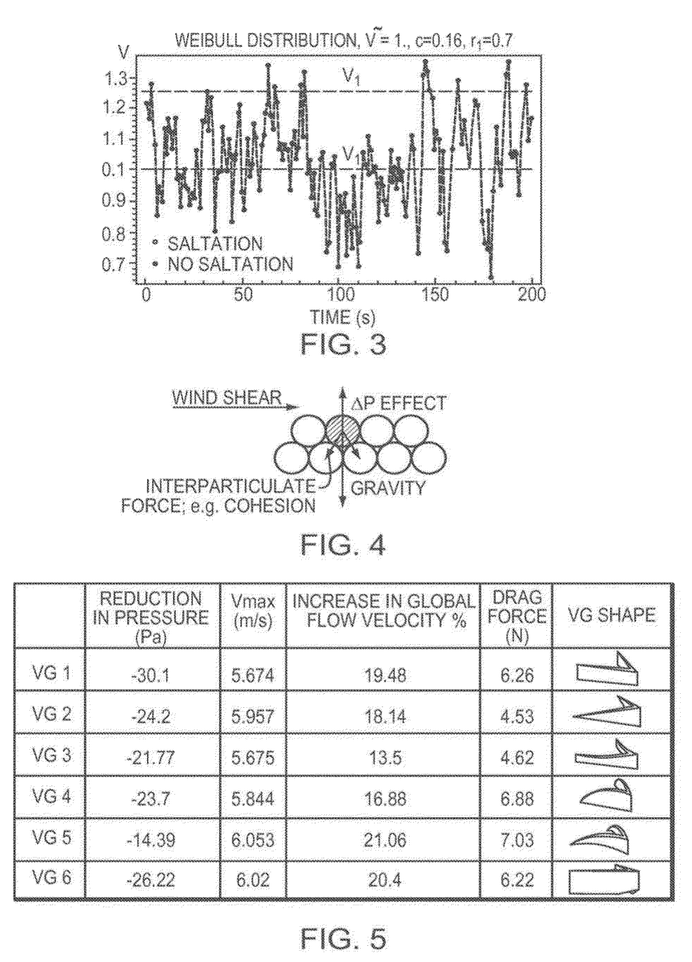

The process is illustrated in FIG. 3. Shown are the two thresholds, the impact threshold of one and the fluid threshold with one point twenty five. The saltation process begins when the fluid threshold is overcome and stops, when the wind falls below the impact threshold. The saltation process depends on how frequently the wind speed exceeds the fluid threshold and how long the wind speed stays over the impact threshold. Therefore it also depends on spectral parameters of the wind. The simplest parameter to describe a spectrum is the autocorrelation function with a time shift of one delta t. In the following, a time shift of one second is used. See B. Martcorena and H. J. Schonfeldt.

### Wind Vortex Effect on Dust Motion

Greeley et al. show that vortex motions can lift both sand and dust, and that vortex motion appears to be more efficient than simple boundary layer winds for lifting dust. See R. Greeley et al., “Martin Dust Devils: Laboratory Simulations of Particles Threshold,” J. of Geophysical Research, Vol. 108, No. E5, 5041, 2003, incorporated herein by reference.

There are at least two mechanisms by which a vortex lifts particles into the atmosphere.
1. The first is the upward component of force caused by frictional drag of winds moving over the bed of particles, which is analogous to the wind shear that lifts particles in simple boundary layer winds. (particles>60 μm in diameter)
2. The second mechanism, referred to herein as the “Δeffect” is the decrease in pressure found at the center of the vortex (FIG. 4) which leads to a lift on the particles as the vortex sweeps across the surface. Opposing these effects are the weight of the particles and inter-particle cohesion.

### Preferred Embodiment

A key aspect of some embodiments of the invention is a panel that can be mounted to a structure that moves it. If good control is provided for the wind spectrum (amplitude and vibration) acting on features on the panel, the leading edge can generate vortices and vibration to provide the cleaning effect.

Improving the aerodynamic properties by adding some geometrical features for the panel may help control the air flow velocity across the panel surface, and, at the same time control the vortex-induced vibration (VIV). Preferably, one knows the frequency and amplitudes needed to make the panel surface move with high kinetic energy (vibration at some selected frequencies with a small amplitude).

To create an effective design in accordance with embodiments of the invention, one considers the aerodynamic characteristics of the panel system to get the required wind and excitation vortex-induced dynamic forces to provide energy for sand movement. This includes study of the aerodynamic characteristics of the parabolic collector panel, to evaluate the velocity and pressure distribution on the panel surfaces to prevent accumulation of dust and sand particles on the panel surface at different working configurations. This includes the following:
The effect of adding deferent types and shapes of vortex generators (VGs) on dynamic pressure, velocity, drag-lift-pitch forces during air flow around the panel features.
The effect of adding holes at edges of the panels

Vortex generators are passive devices that can be sized to nestle within the boundary layer and that can pump energy into the boundary layer of a following medium to keep particles entrained in the media and prevent them from settling out.

One embodiment of a vortex generator is a “male” V form resembling a wishbone that is positioned on a flow control surface with its apex pointing downstream. The generators resemble two short vane vortex generators positioned so that their training edges touch. Each vortex has a diameter of up to five times the maximum height of the sidewalls above the surface on which the generator is installed.

The vortex generator preferably has an included angle selected from a range of 15 to 80 degrees. In principle, wide platforms are more desirable than narrow ones because they create vortices with higher rotational speed, which is good for low speed flow.

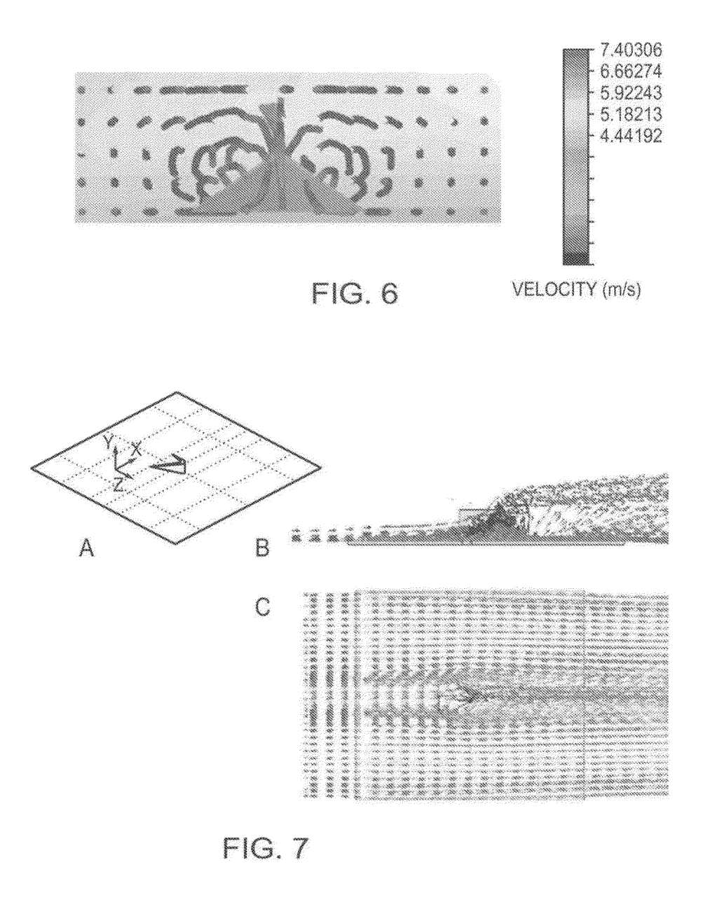

Different types and shapes for VGs have been investigated using computational fluid dynamics (CFD) analysis. FIG. 5 shows the studied VGs (i.e., VG1, VG2, VG3, VG4, VG5, and VG6). The flow trajectories simulation for VG1 is shown in FIG. 6. In addition to the following discussion of the studied VGs, additional experimental results are presented in the section entitled “Examples.”

The lifting effect of the wind shear can be derived if the velocity of the vortex is known, as it depends on the greatest wind velocity in the low. The lifting effect of the pressure decrease at the surface is less easy to quantify because it depends on unknown factors such as how deeply the ΔP effect propagates into the bed of particles and how quickly the pressure deficit is applied.

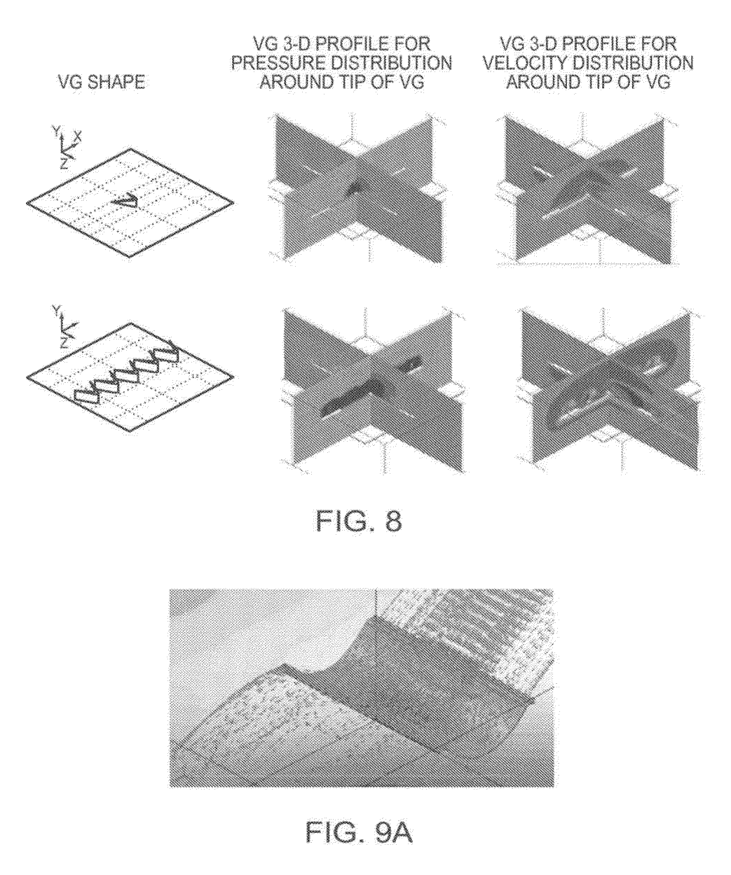

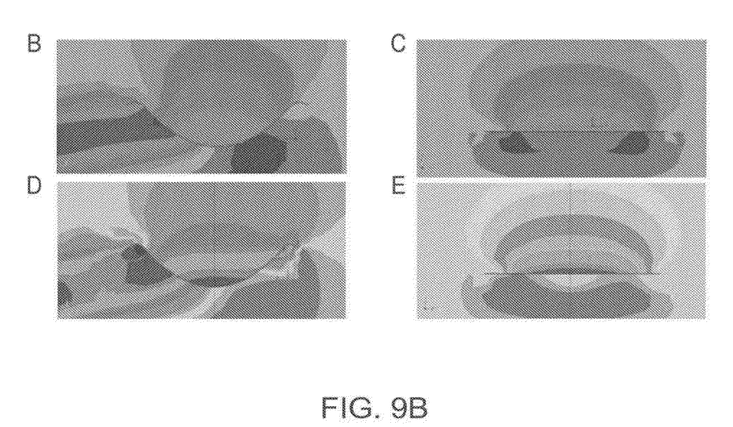

To study the expected effect of the vortex generators on the overall air flow velocity around and near the parabola panel surfaces, a simple model has been developed using Flowworks CFD software, as shown at FIG. 7. FIG. 8 illustrates pressure and velocity distribution around the tip of VG2 and VG1. FIGS. 9a and 9b show flow stagnation inside the inner surface of the panel.

### Effect of Adding Holes to Panel

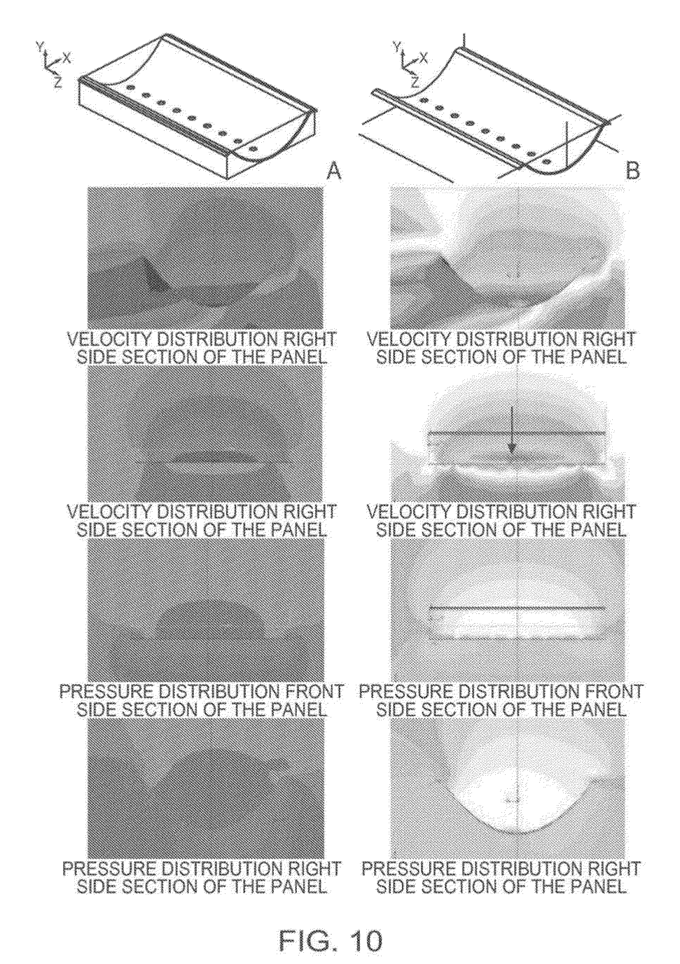

Referring to FIG. 10, air flow simulation using CFD shows that flow at the inner surface of the panel is near stagnation (zero velocity); this happens because the flow kinetic energy of air and high pressure are decreased at the middle of the panel. Hence, it may be preferable to add small holes at the center of the panel to create low pressure regions inside the panel surface, which in turn keep air flow and kinetic energy at required levels to move dust particles from the reflector surface. The effect of these holes on the overall flexural and tensional stiffness of the panel may be taken into consideration. In general, the effect of adding holes at the center of the panel on the velocity and pressure distribution, which decreases the stagnation volume at the center of the parabolic panel and provides air motion over the inner surfaces of the panel, is shown in FIG. 10 which illustrates a panel (a) without holes, (b) nine circular holes at the center (R=1.5 cm), air velocity Vy=−2.5, Vz=4.33 m/s.

### Adding Holes at the Panel Edges

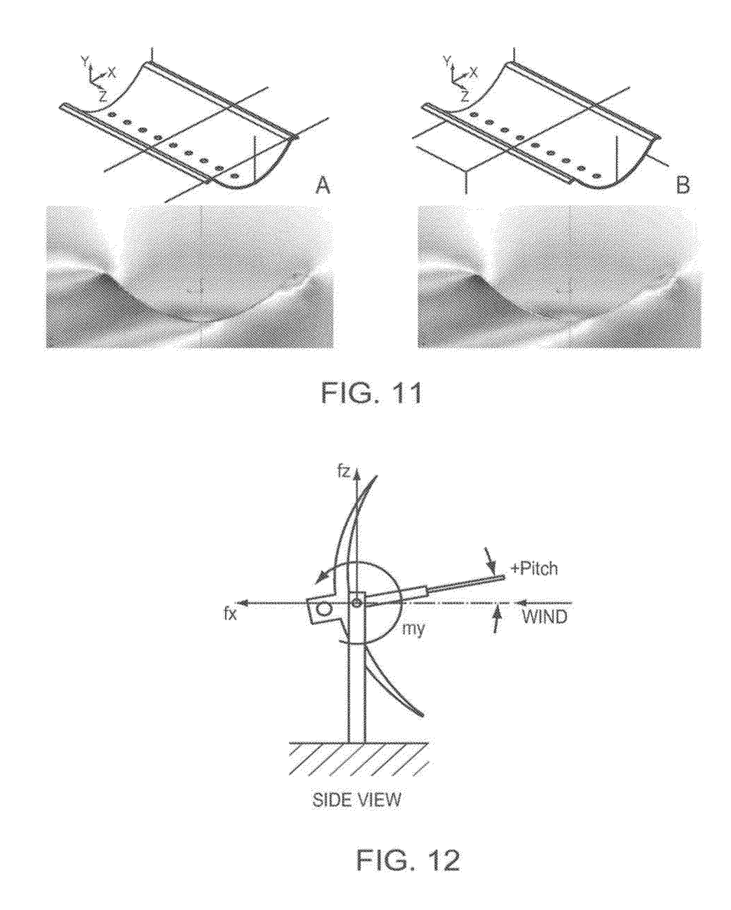

In some embodiments of the invention, a second feature added to the panel is small holes at the edges of the panel. Referring to FIG. 11, this may produce unstable flow regions with high air velocity near panel edges. FIG. 11 shows the affect of adding to the panel the following: (a) nine circular holes at the center (1.5 cm) and twenty triangular holes at the edge (L=1.782 cm), and (b) nine circular holes at the center (R=1.5 cm) and nineteen circular holes at the edges; air velocity Vy=−2.5, Vz=4.33 m/s. One may conclude the following:
Adding holes (circular or triangular) to an edge of a panel produces high air velocity at the edges (edge vortices).
Adding holes (circular or triangular) to an edge of a panel increases air velocity at the inner surface.
Adding holes to the center of a panel lowers a pressure difference (decrease lift and drag forces).

### Geometric Features

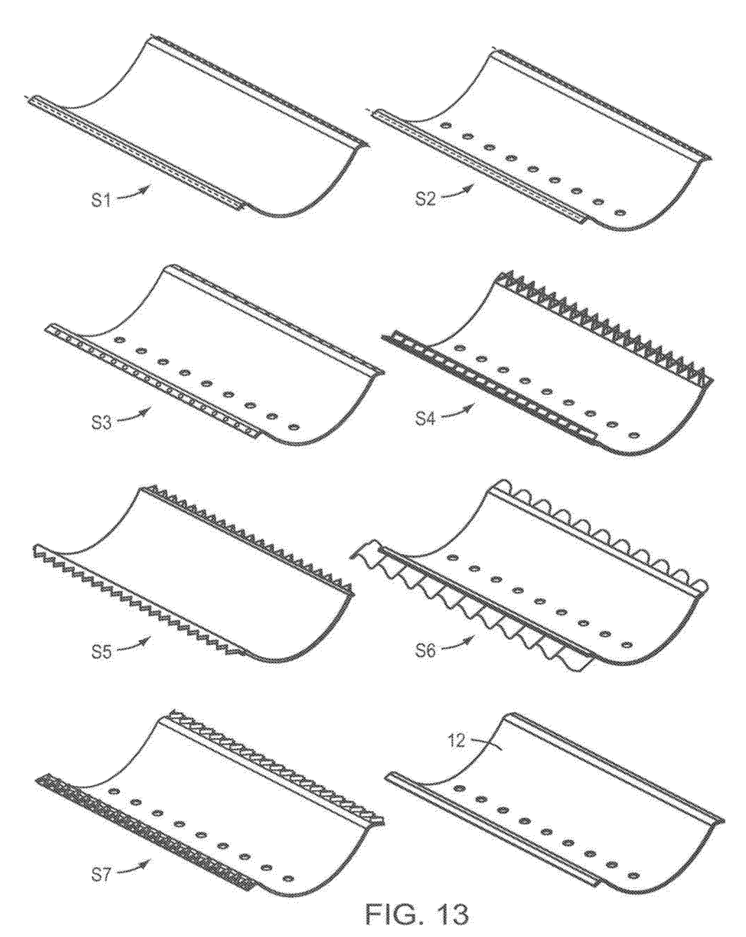

Instead of holes, protrusions may be used to induce vortices. These protrusions may be added features or they may be formed in sheet metal surfaces, or they may be formed by molding. FIG. 12 shows the resultant forces on a parabolic trough from the wind. Referring to FIG. 13, seven scenarios (S1 through S7) are considered using CFD analysis for the resultant air flow features.

Global flow parameters were calculated [maximum air velocity, maximum dynamic pressure, maximum global turbulent kinetic energy (GTKE), maximum drag forces (Fy), maximum lift forces (Fz), maximum bending moment (Mz), and the shear forces on surface 12 (S1 TKE)]. These parameters were calculated for five panel pitch angles (30, 60, 90, 120, 150, and 180 degrees).

### The Turbulence Kinetic Energy (TKE):

TKE is the mean kinetic energy per unit mass associated with eddies in turbulent flow. Physically, the turbulence kinetic energy is characterized by measured root-mean-square (RMS) velocity fluctuations. The turbulence kinetic energy can be calculated based on the closure method, i.e., a turbulence model. Generally, the TKE can be quantified by the mean of the turbulence normal stresses. TKE can be produced by fluid shear, friction or buoyancy, or through external forcing at low-frequency eddies scales (integral scale).

### Static and Dynamic Pressure:

To distinguish it from the total and dynamic pressures, the actual pressure of the fluid, which is associated not with its motion but with its state, is often referred to as the static pressure. Where the term pressure alone is used, it refers to this static pressure. For incompressible flows, the pressure of the fluid can be expressed as:

$$P + \frac{1}{2} {ρυ}^{2} = {P}_{0} ,$$

### Where:

P is static pressure,

$$\frac{1}{2} {ρυ}^{2}$$

is dynamic pressure, usually denoted by q,

ρ is the mass density of the fluid,

ν is the flow velocity, and

P₀ is total pressure which is constant along any streamline.

### Load Coefficients:

$$Horizontal Force , fx Cfx = \frac{fx}{qLW}$$

$$Vertical Force , fz Cfz = \frac{fz}{qLW}$$

$$Where q = \frac{1}{2} ρ {U}^{2}$$

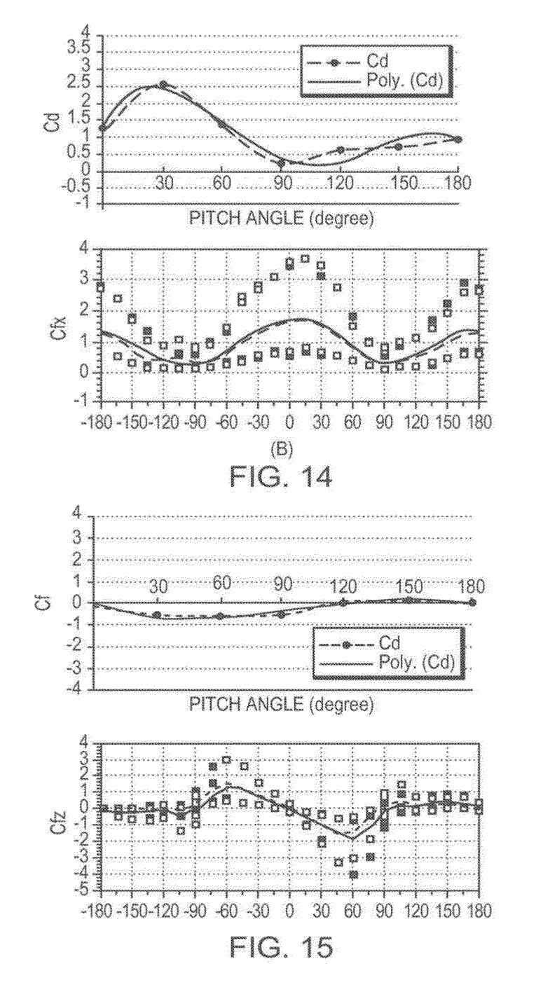

Referring to FIGS. 14 and 15, the drag (Cd) and lift (Cf) coefficients obtained from the developed CFD model had a good trend agreement with that from wind tunnel test given at Hosoya, et al. The difference in the coefficients values is related to the difference in aspect ratio between theoretical and experimental panel dimensions.

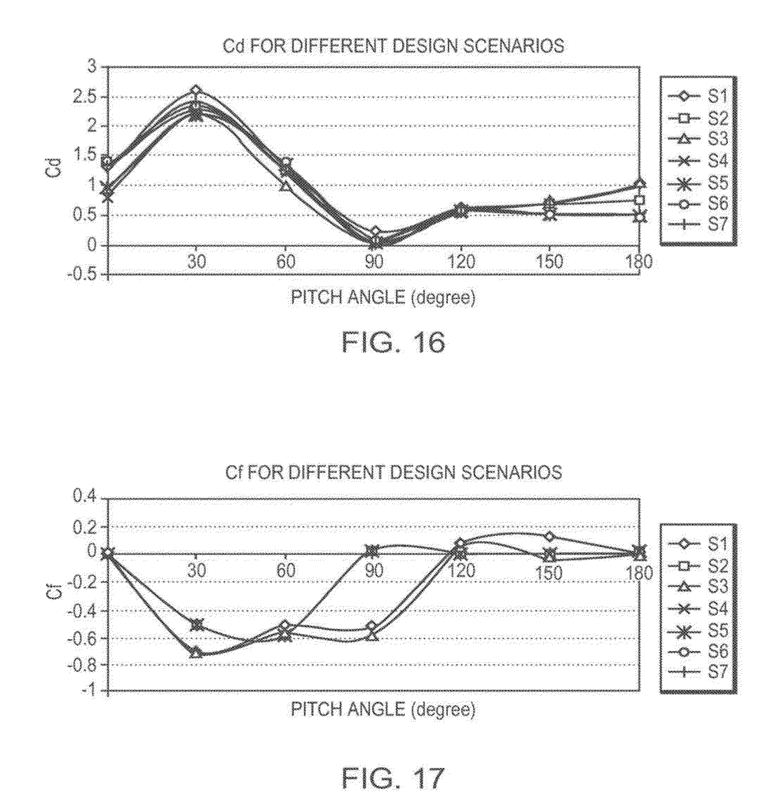

### Drag Coefficient (Cd), FIG. 16:

Maximum Cd occurs at a pitch angle of about 30°, and this is in agreement with results obtained experimentally for parabolic panel 1, as shown in FIG. 1
Minimum Cd occurs at a pitch angle of about 90°.
Scenarios S2, S3, S4, S5, S6 and S7 produce a decrease in Cd of 14.4, 14.7, 12.2, 13.7, 8.8, 6.9% respectively with respect to the scenario S1.
Scenarios S3, S4, S5, S6 and S7 produce an increase in Cd of 0.1, 3.1, 1.4, 7.15, 9.4% respectively with respect to scenario S2.

### Lift Coefficient (Cf), FIG. 17:

Maximum Cf occurs at a pitch angle of about 30° for scenarios S1, S2 and S3.
Maximum Cf occurs at a pitch angle of about 60° for scenarios S4, S5, S6 and S7.
Minimum Cf occurs at a pitch angle of 0 for all scenarios and at 90, 120, 150 and 180° for scenarios S4, S5, S6, and S7.

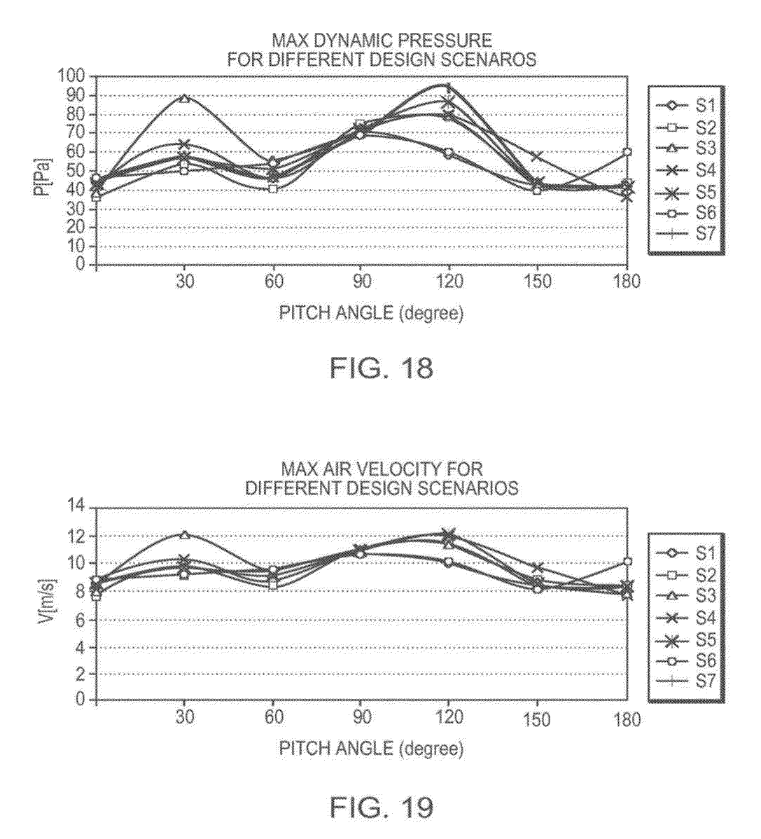

### Flow Dynamic Pressure (q), FIG. 18:

Maximum q occurs at a pitch angle of about 30° for scenario S3.
Maximum q occurs at a pitch angle of about 120° for scenarios S2, S4, S5 and S7.
Maximum q occurs at a pitch angle of about 90° for scenario S6.

### Flow Velocity, FIG. 19:

Maximum flow velocity occurs at a pitch angle of about 30° for scenario S3, and with a value of 26.01% higher than velocity at S1.

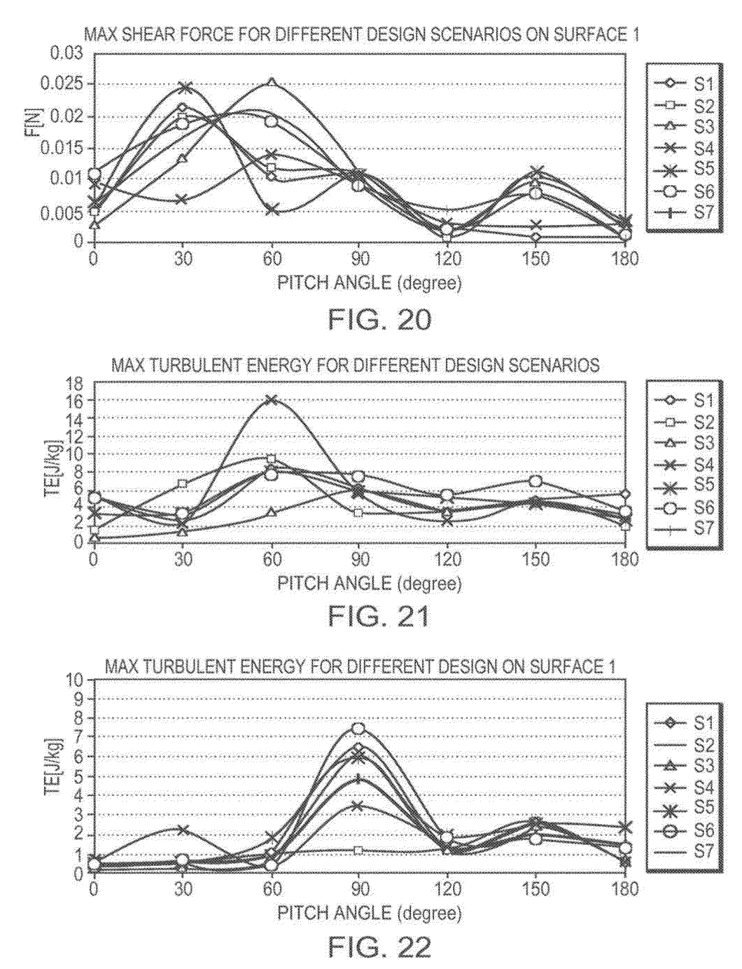

### Shear Force at Surface 12 (SF), FIG. 20:

Maximum SF occurs at a pitch angle of about 30° for scenarios S1, S2 and S5.
Maximum SF occurs at a pitch angle of about 60° for scenarios S3, S4, S6 and S7.
Maximum SF occurs at a pitch angle of about 30° for scenario S5, and with a value of 15.33% higher than velocity at S1.
Maximum SF velocity occurs at a pitch angle of about 60° for scenario S3, and with a value of 147.01% higher than velocity at S1.

### Global Turbulent Kinetic Energy (GTKE), FIG. 21:

Maximum GTKE occurs at a pitch angle 60°.
Scenarios S2, S4, and S7 produce an increase in the GTKE of 12.38, 90.8, and 0.7% respectively with respect to S1.
Scenario S4 provides an increase in GTKE of 69.8% with respect to scenario S2.
GTKE decreases for all other scenarios with respect to scenario S1.

### Turbulent Kinetic Energy (S1TKE) for Surface No. 1 (Inner Surface) FIG. 22:

Maximum S1TKE occurs at a pitch angle of 90°.
Scenario S6 produces an increase in the S1TKE of 16.7 with respect to S1.
S1TKE decreases for all other scenarios with respect to scenario S1.
Scenarios S3, S4, S5, S6 and S7 provide increases in S1TKE of 390.4, 193.2, 400.8, 537.3 and 301.0% respectively with respect to the scenario S2.

### Selection of Features and Self Cleaning Properties:

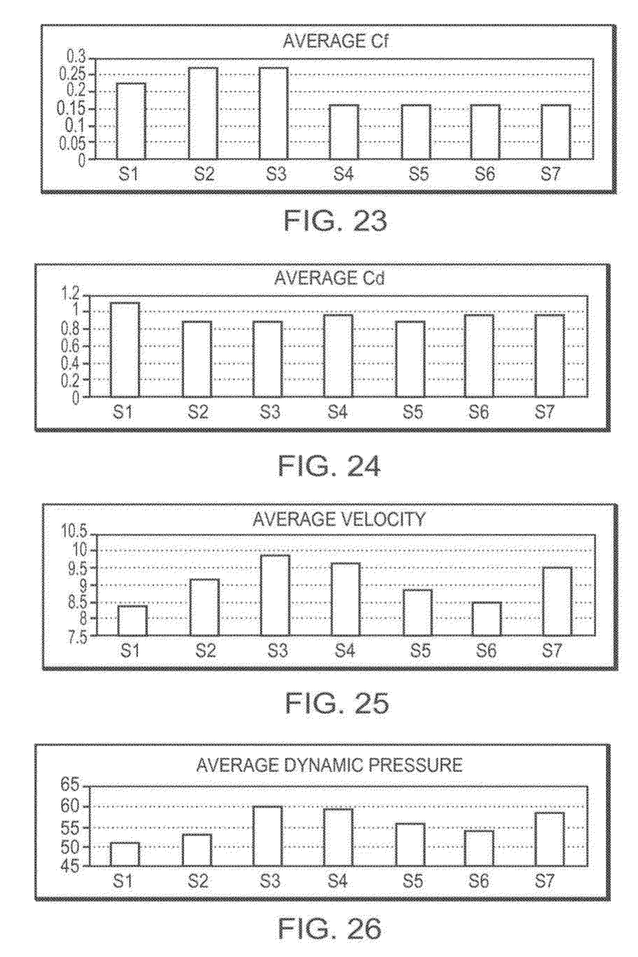

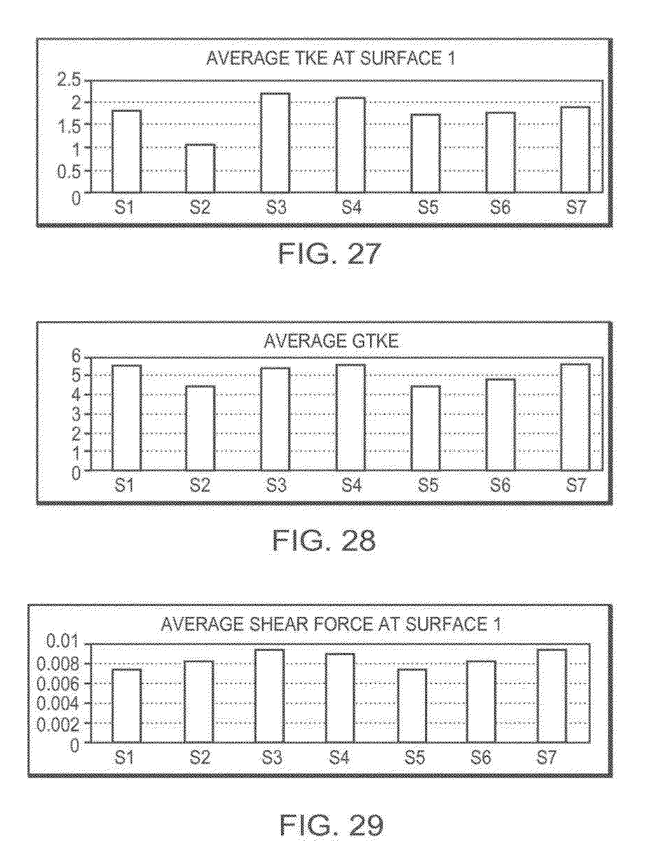

The average values for Cd, Cf, GTKE, S1TKE, q, velocity, and shear forces had been calculated for all tested pitch angles as shown in FIGS. 23-29. The selection criteria included selecting the design scenario with minimum aerodynamic forces (Cd and Cf), maximum global turbulent energy (GKTE), maximum surface 1 turbulent energy (KTES1), maximum air velocity, and maximum dynamic pressure. Based on the investigation of the average values of the above criteria in FIGS. 23-29, it was determined that scenarios S3 or S4 or S7 are particularly preferable.

For a cleaning configuration, at night for example, a 30-60 degree pitch in the face of the wind may provide maximum turbulent kinetic energy and dynamic pressure. This helps to vibrate the surface to some frequencies.

### Prediction of Vortex-Induced Wind Loading on a Parabolic Panel

In investigating vortex-induced vibrations, it is important to accurately predict not only the magnitude and frequency of unsteady wind loadings but also the amplitudes of the resulting structural vibrations. See Sangasan Lee et al., “Prediction of Vortex-induced Wind Loading on Long-span Bridges,” Journal of Wind Engineering and Industrial Aerodynamics 67&68 (1997) 267-278, incorporated herein by reference. Structural oscillation tends to be violent when the wind loading frequency falls near the structural natural frequencies due to resonance. For the accurate prediction of wind structure interaction, flow structure coupled problem should be analyzed, where effects of the structural movement are incorporated in the governing equations in the form of mesh movement velocity.

Flow around the structure, however, is modified significantly by the structure motion only when the vibration amplitude in the cross-wind direction exceeds 10% of the structure size. Since a structural oscillation in that amount is clearly beyond the design safety limit, the panel section may safely be assumed to be fixed in space throughout the computational fluid dynamics (CFD) analysis in most engineering considerations. The computational procedure for analysis of the vortex-induced vibration is performed through a two-step process. In the first step, commercial CFD software, FIOWWORKS 2008, is used to analyze turbulent flows around the bridge deck section to predict unsteady wind loadings on the structure. In the second step, commercial structural analysis software, COSMOSWORKS 2008, is used to compute the structural response under the wind loading predicted in the first step. Herein, emphasis is put on the CFD analysis, and a brief description of the structural analysis results follows to validate the overall analysis procedure.

In performing CFD analysis, the choice of numerical schemes, grid system, and physical turbulence model is based on the systematic investigations of unsteady turbulent flows over bluff bodies.

### Wind Loading Characteristics

The three-dimensional panel model and grid system around it were modeled with about 12 000 cells for the CFD analysis. Incoming flow is uniform at the design speed of U=7 m/s, with a panel pitch angle of 30 degrees selected to get the maximum drag forces according to the results discussed above. It was assumed that the flow was turbulent with a turbulence intensity of 3%.

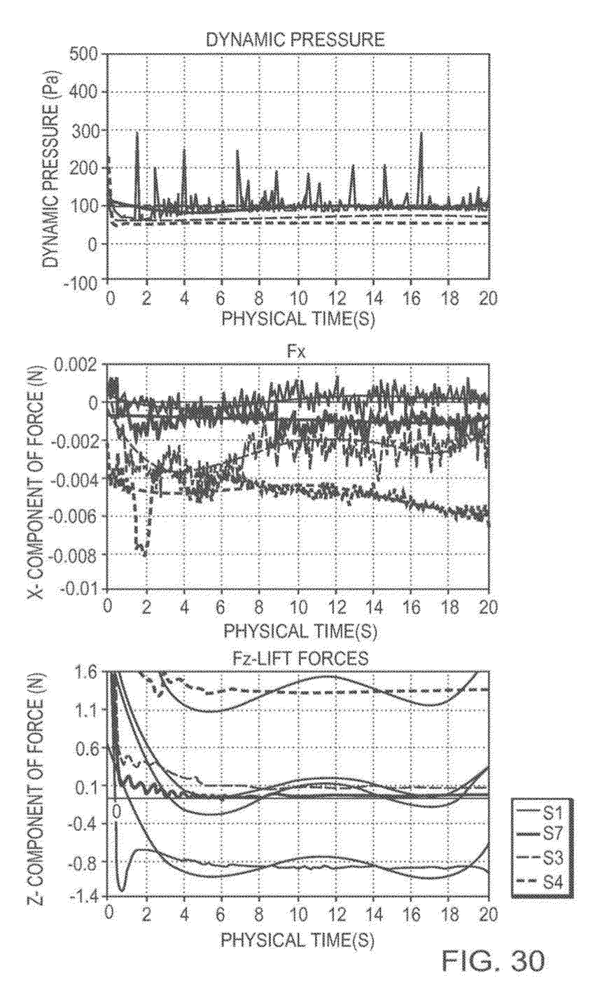

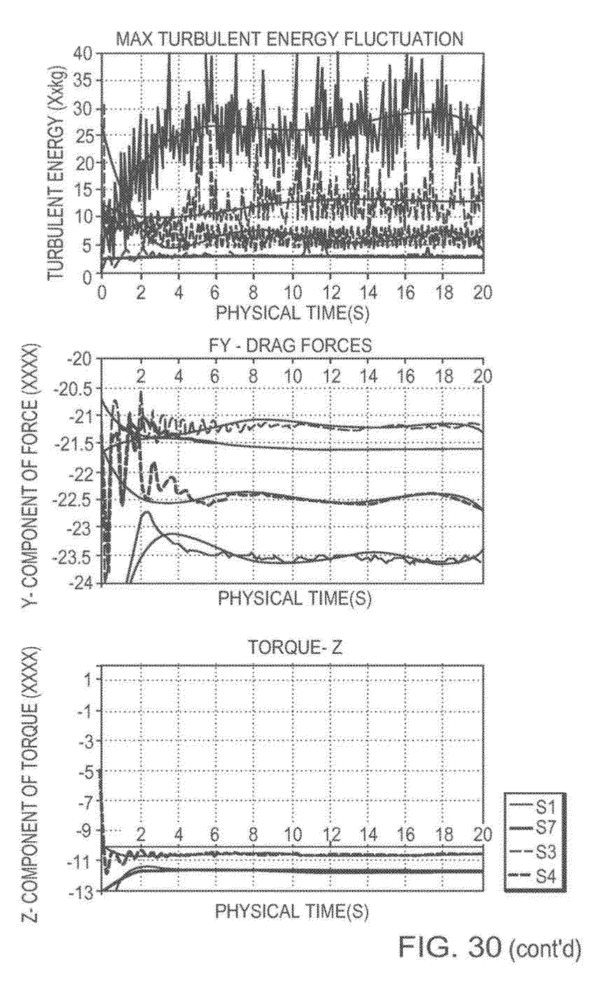

FIG. 30 summarizes the results for 20-second simulations of air flow around the CFD test panel model, where the GTKE, dynamic pressure, Y-force (drag forces), Z-force (lift forces), x-force and Z-Torque are plotted and with their trendline to predict the change behavior for each flow parameters.

### Prediction of Wind Frequency Spectrum

The major contributor to unsteadiness is alternately generated and shed vortices at the leeward side of the panel, while almost time-independent recirculation regions are sitting at its windward side. Similar flow feature and time dependence are observed at different wind speeds at previous sections.

The two important factors investigated are the dominant frequencies of the wind loadings and their fluctuating amplitudes. Time history of the lift coefficient is taken for the dominant frequency (f) estimation by FFT through a proper windowing to remove the signal non-periodicity effects in the Fourier transform. Dependence of wind loading frequency on the incoming wind speed was studied by Sangasan Lee et al., and shows that the frequency is almost linearly proportional to the wind speed. Magnitudes of the mean and fluctuating force coefficients are found to be fairly insensitive to the wind speed.

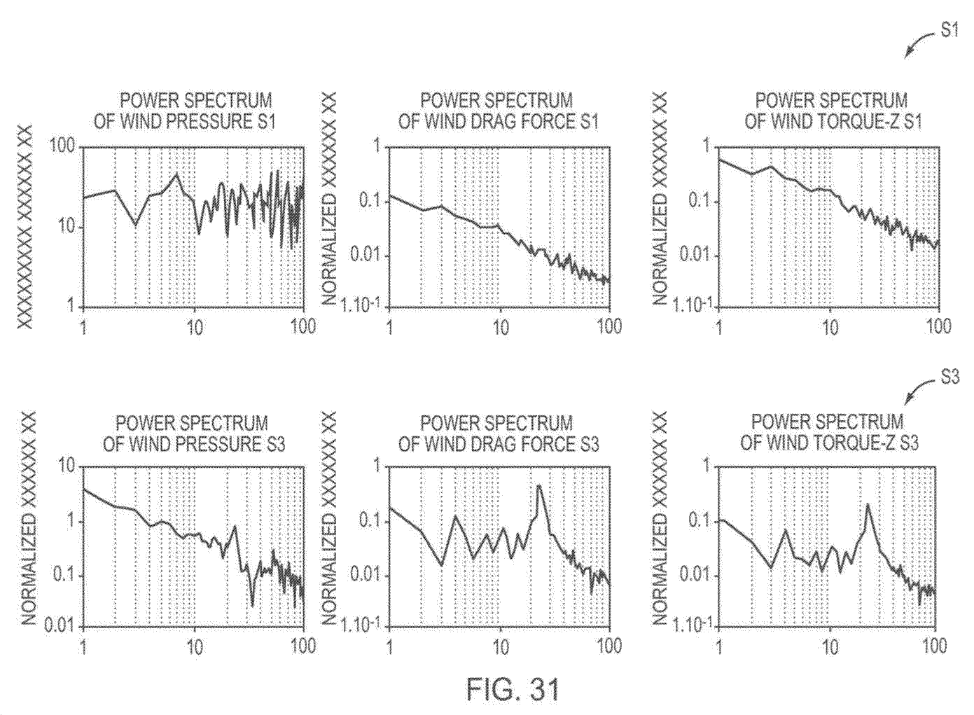

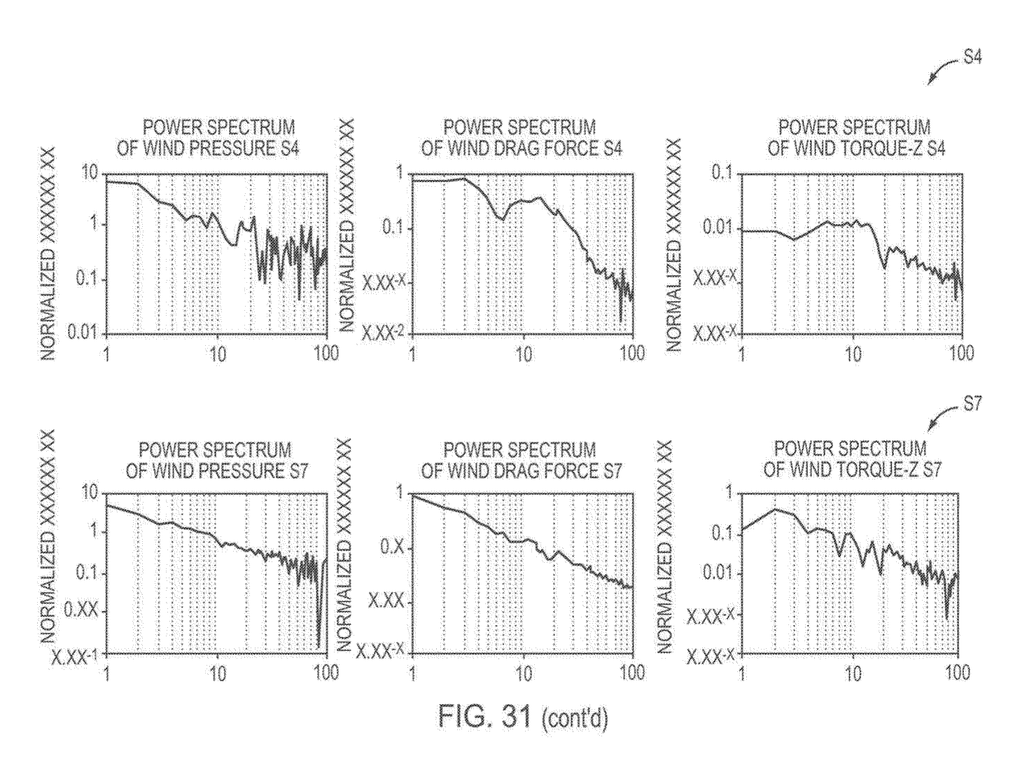

FIG. 31 shows the frequency spectrum for the original panel (S1) and for design scenarios S3, S4, S7. In the second case, the main dominant frequency is in the range of about 2-10 Hz for S1 and in the range 20-30 Hz for S3. The amplitude of vibration of S1 is greater than vibration amplitude for S3.

In general adding holes to the panel will increase the dominant frequency value of the wind forces fluctuation and decrease the fluctuation amplitude for the wind forces. This effect depends on wind velocity, panel pitch angle, and hole size. The dynamic pressure peak almost coincides with the peak of the fluctuating wind forces.

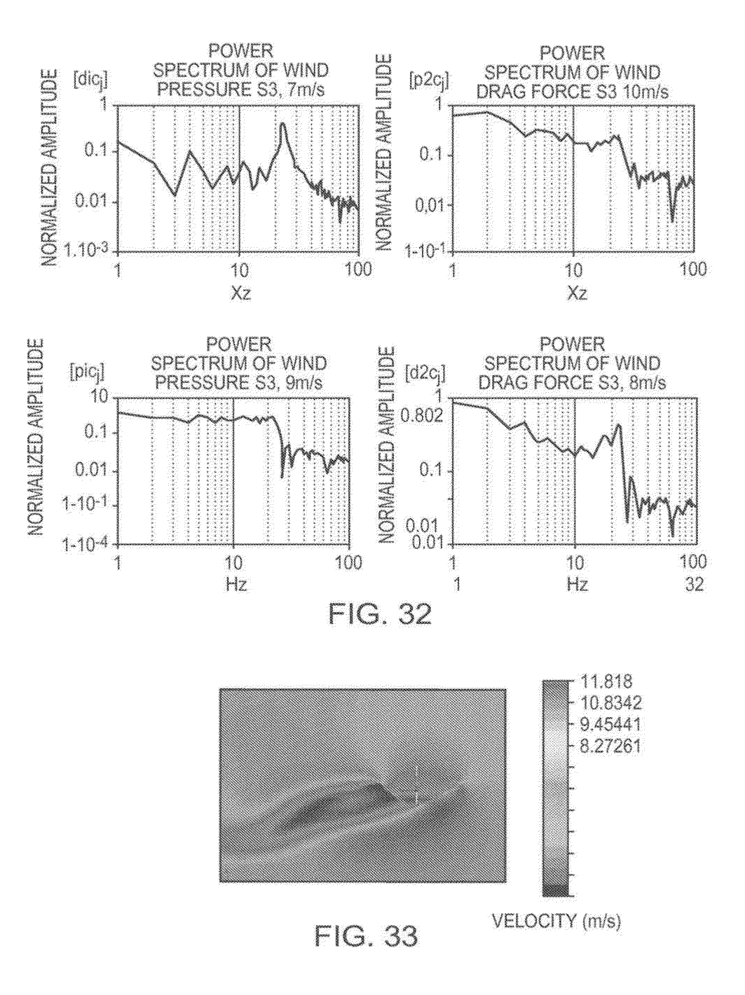

To study the effect of wind velocity, four different wind velocities were considered in this analysis: 7, 8, 9, and 10 m/s with zero yaw angle. FIG. 32 shows the frequency spectrum for resultant drag forces (Fy). The dominant frequency is nearly in the same range (20-30 Hz with lower amplitude), and this does not agree with results given at Sangasan Lee et al. for bridge wind-induced vibration. FIG. 33 shows air velocity distributions for around the panel for wind velocity 9 m/s and panel pitch angle 30°.

### Prediction of Wind-Induced Response of Parabolic Panel

Computation is performed to investigate the unsteady wind loadings on the structure and the loadings will later be used as time-dependent external forces in the subsequent dynamic structural analysis.

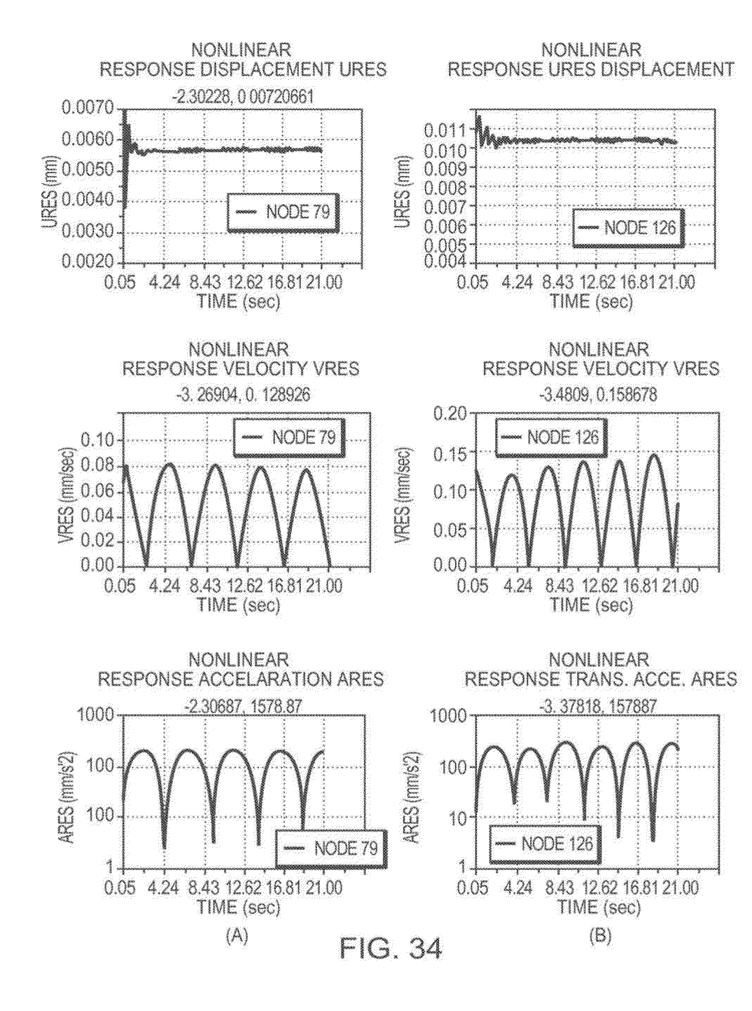

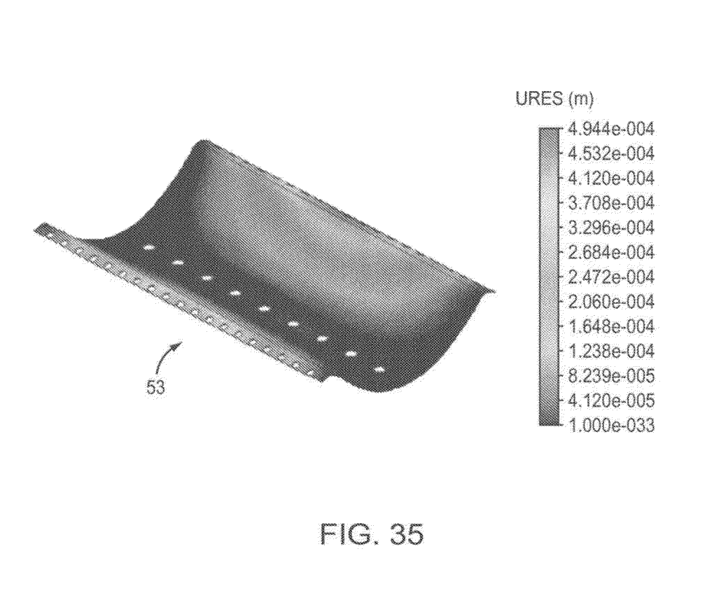

The non linear displacement, velocity and acceleration response for the panel subjected to time dependent wind forces at wind speed 7 m/s with 30 degree panel pitch angle are shown in FIG. 34A-34B. FIG. 34A shows the non-linear response for the original panel without any additional features (S1), FIG. 34B shows the non-linear response for the design scenario (S3) (without including damping). The following observations are noted:
1. The amplitude of displacement, velocity and acceleration is higher for scenario S3. This may be related to the decrease in panel stiffness due to adding the holes at the center and edges.
2. The fluctuation of displacement, velocity, and acceleration for S3 is greater by 50% than for the original design (S1). This may be related to increasing the dominant frequency for S3 as discussed above.
   FIG. 35 shows the displacement plot due to wind load effect for design scenario S3 (wind speed 7 m/s, panel pitch angle 60°)

### Preferred Embodiment Recommendations

1. Making holes at the center and edges of the parabolic panel like in scenario S3, produces turbulent flow (high speed air) near the edges of the panel and induces vibration at the panel due to high fluctuating at turbulent energy and dynamic pressure. The same behavior is predicted for adding vortex generators as given in scenario S4.
2. The parabolic panel responds to these fluctuating wind forces at different levels according to the dominant frequency of the wind forces.
3. The continuous response of the panel to the wind dynamic force produces a large field of low amplitude surface displacements that help prevent the dust particles from sticking, and provides these particles with the energy required for motion to outside the panel.
4. The dominant wind frequency of wind fluctuation can be controlled by selecting the edge hole size and computational fluid dynamics or wind tunnel tests can be used to tune the desired effect. This may be evaluated according to the panel size and the expected wind velocities for the working conditions of the parabolic panels.
5. Holes at the center of the panel reduce the stagnation pressure volume at the inner surface and produce spots of low pressure volumes that can help keep air flow near the panel inner surface. This may help keep motion of dust particles along air flow trajectories outside the panel inner surface.
6. Adding holes or vortex generators may help maintain the maximum value of turbulent energy and reduce the aerodynamics loading for the panel structures. Increasing the air kinematic viscosity produces increases in air shear forces around the panel surfaces, and increases in these shear forces may help increase the motion of dust or sand particles, especially if the shear forces are kept higher than threshold shear forces for the required period.

Referring to FIG. 36, in some preferred embodiments of the invention, a solar panel 20 is configured to reduce contaminant accumulation thereon. The solar panel 20 includes a surface 22 adapted to receive or redirect solar energy and/or harvest solar energy. The surface 22 may define a parabolic-shaped trough 24.

A vortex-inducing generator 26 comprising a plurality of chevron-shaped features 28 is disposed across at least a portion of the surface 22. As used herein, each of the chevron-shaped features 28 may be also be considered to be a discrete vortex-inducing generator 26. The vortex-inducing generator 26 may be rigid and may include or consist essentially of a UV-resistant polymer, metal, glass, and/or a composite. The vortex-inducing generator is configured to cause air flow passing over the surface to reduce contaminant accumulation thereon. As depicted, the panel 20 may include holes 30 in a bottom of the trough 24.

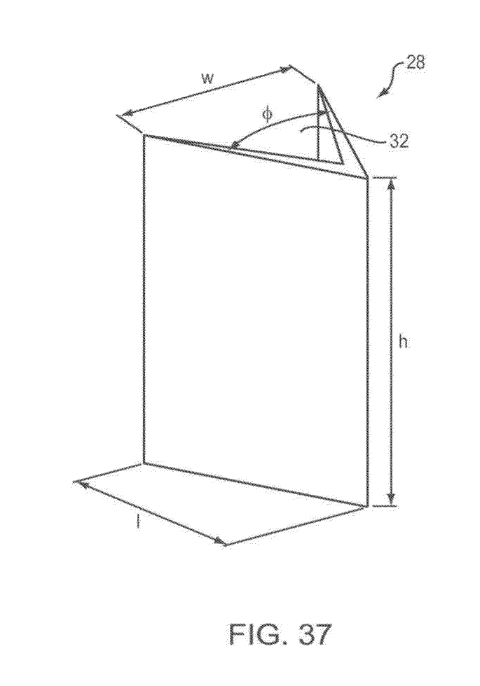

The chevron-shaped features may have any of vortex generator shapes VG1-VG6, or any other design suitable for separating air flow. Referring also to FIG. 37, at least one chevron-shaped feature 28 may define an included angle θ selected from a range of about 30 degrees to about 120 degrees. As depicted, in some embodiments, at least one chevron-shaped feature has a maximum length l and defines an opening having a maximum width w and a maximum height h. In one embodiment, maximum width w is equal to a, and the chevron-shaped features are disposed on the solar panel surface at a pitch P selected from a range of about 1.5a to about 5a. In another embodiment, at least one chevron-shaped feature defines an opening 32 having a maximum width w equal to a, a maximum height h of about 2a, and a maximum distance l from the apex to the open end of the chevron-shaped feature of about a. At least one or each chevron-shaped feature may have a constant height (see, e.g., vortex generator shape VG1), a varying linear height (see, e.g., vortex generator shape VG2), or a varying nonlinear height (see, e.g., vortex generator shapes VG3 and VG4). At least one, or each, chevron-shaped feature may form a gap with the surface along at least a portion thereof (see, e.g., vortex generator shapes VG5 and VG6). At lease one or each chevron-shaped feature may be oriented at an angle selected from a range of ±45° relative to an edge of the surface.

The surface may define a plurality of openings. The solar panel may include a supporting structure for the surface.

A solar panel may be passively cleaned as follows. A solar panel may include a surface adapted to redirect solar energy. The solar panel may also include a vortex-inducing generator comprising a plurality of chevron-shaped features disposed across at least a portion of the surface proximate a leading edge. The vortex-inducing generator may reduce contaminant accumulation on the surface by causing air flow passing over the surface to remove at least some contaminants deposited thereon and/or keeping particles entrained in the air flow to reduce deposition on the surface. The solar panel may be positioned such that the leading edge is oriented to intercept a prevailing wind direction.

The positioning step may include using wind velocity (speed and direction) sensors which then, based on accumulated experience for a site, would enable the control system to position the trough. An accelerometer could also be used were the angle of the trough is controlled to maximize vibration. This would be particularly effective at night.

A supporting structure, such as a truss system which is well known to those skilled in the art of parabolic solar trough design, may be provided for the surface. The supporting structure may be adapted to move the surface to, e.g., track the solar energy and/or intercept a changed wind direction. In one embodiment, posts 27a and 27b are located at each end of parabolic-shaped trough 24. A lower truss structure 27c (at both ends of the trough) allows the trough to pivot about the top of the posts under control of actuators 23, which may be hydraulic motors or a hydraulic linkage or an electric motor/gearbox, or any other suitable prime mover. At both ends of the trough, upper truss 27d (or a single large kingpost) extends up from truss 27c to support the receiving tube 29 which is located at the focal point of the trough.

In certain embodiments, the support structure includes a panel positioning system that may be used to position the panel with respect to the wind direction. A method of positioning the panel may include (i) measuring the wind velocity and/or vibration of the panel, and (ii) actuating the panel positioning system to position the panel according to the measured wind velocity and/or vibration of the panel. The panel may be positioned according to a previously known best position for a given wind velocity.

A solar array may include a plurality of solar panels, with each solar panel including (i) a surface adapted to redirect solar energy, and (ii) a vortex-inducing generator comprising a plurality of chevron-shaped features disposed across at least a portion of the surface proximate the leading edge. The vortex-inducing generator may reduce contaminant accumulation on the surface by causing air flow passing over the surface to remove at least some contaminants deposited thereon and/or keeping particles entrained in the air flow to reduce deposition on the surface. Each solar panel may be positioned such that the leading edge is oriented to intercept a prevailing wind direction.

### EXAMPLES

### Experimental Results with Vortex Generators

### Simulation

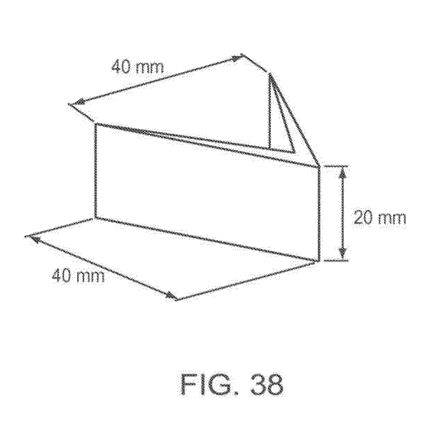

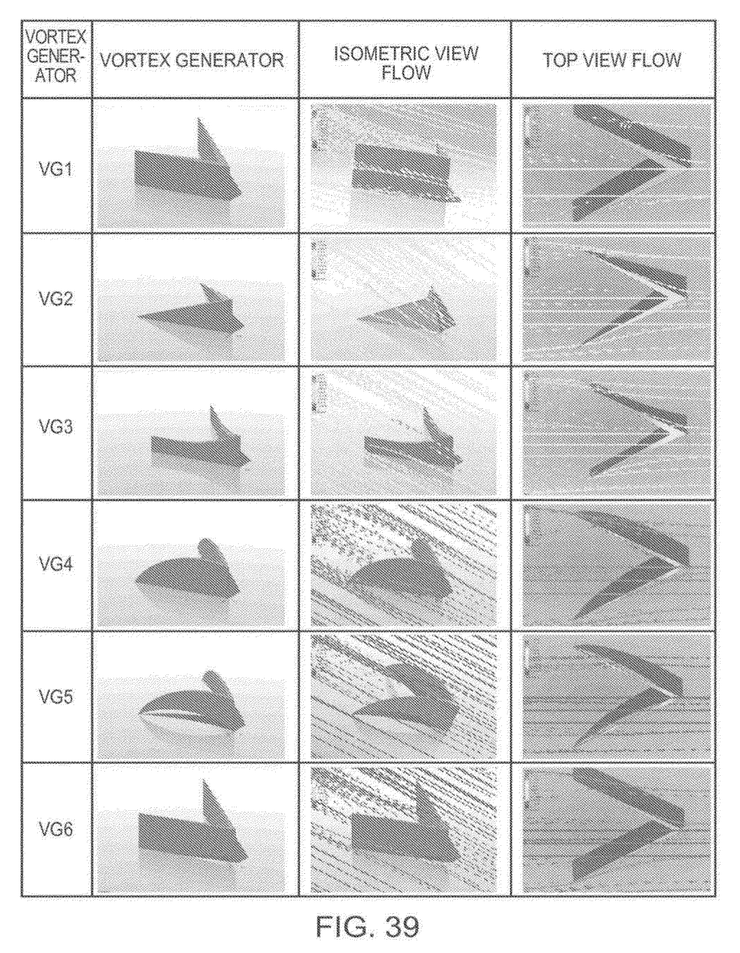

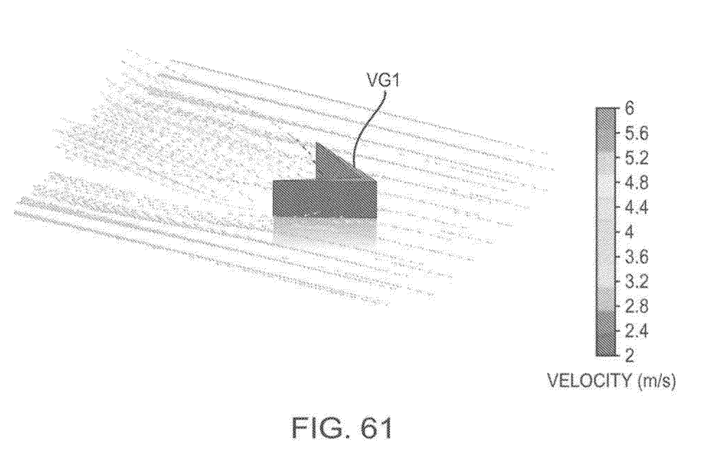

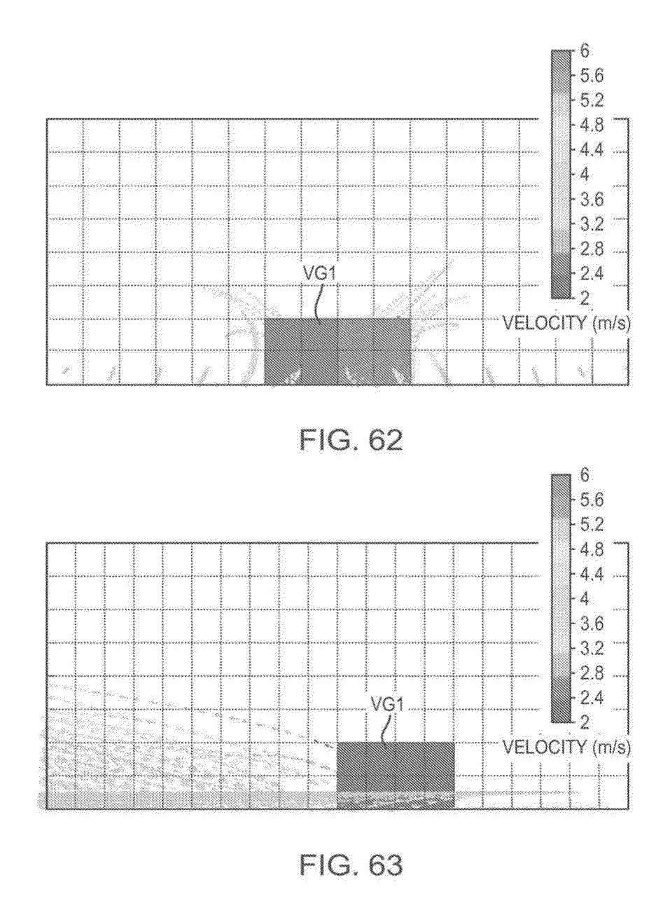

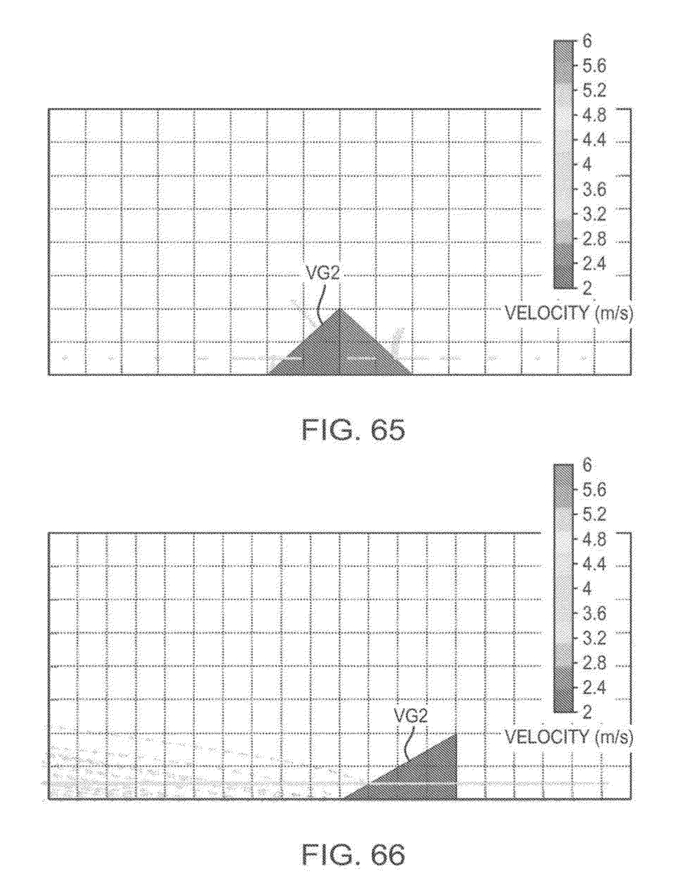

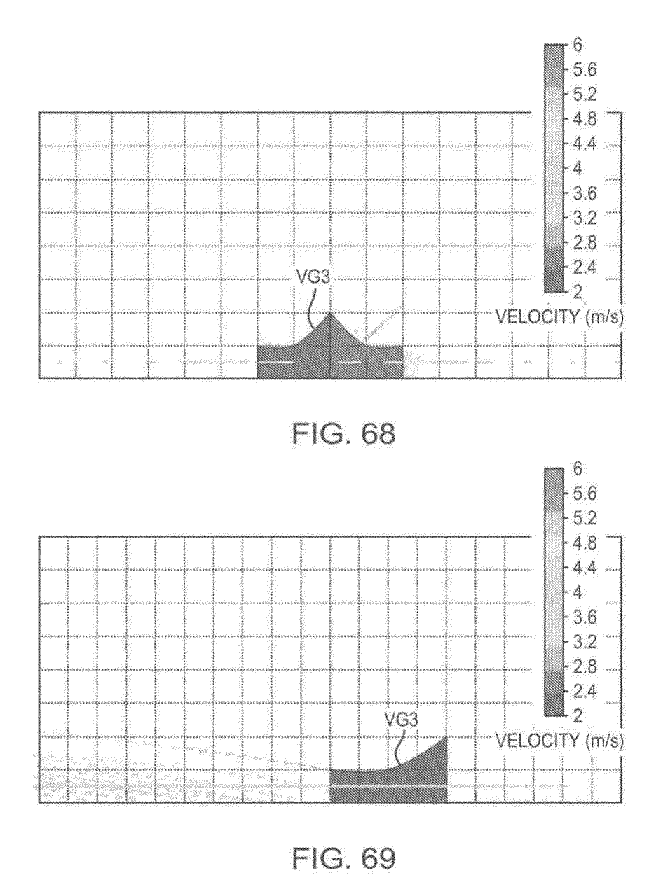

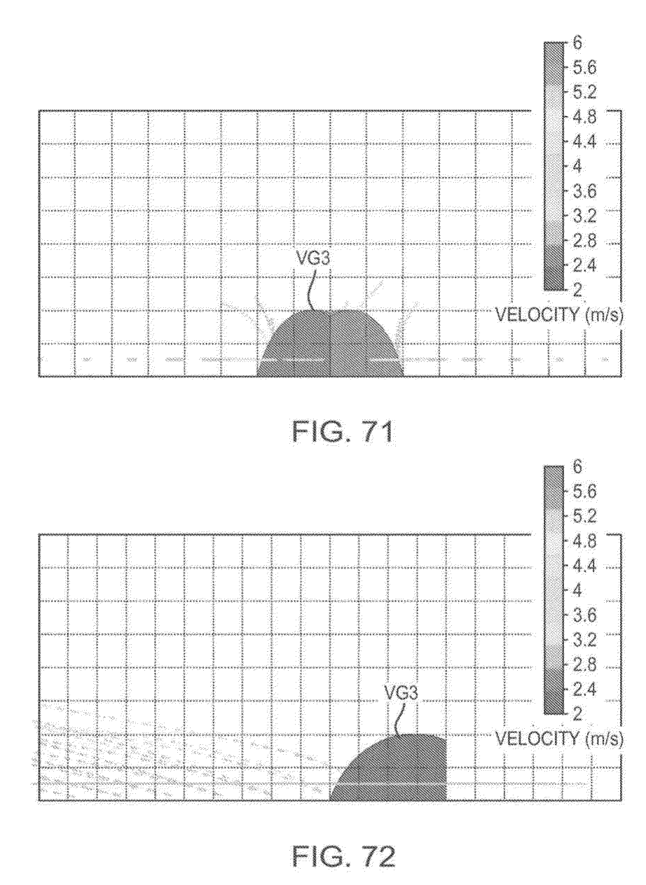

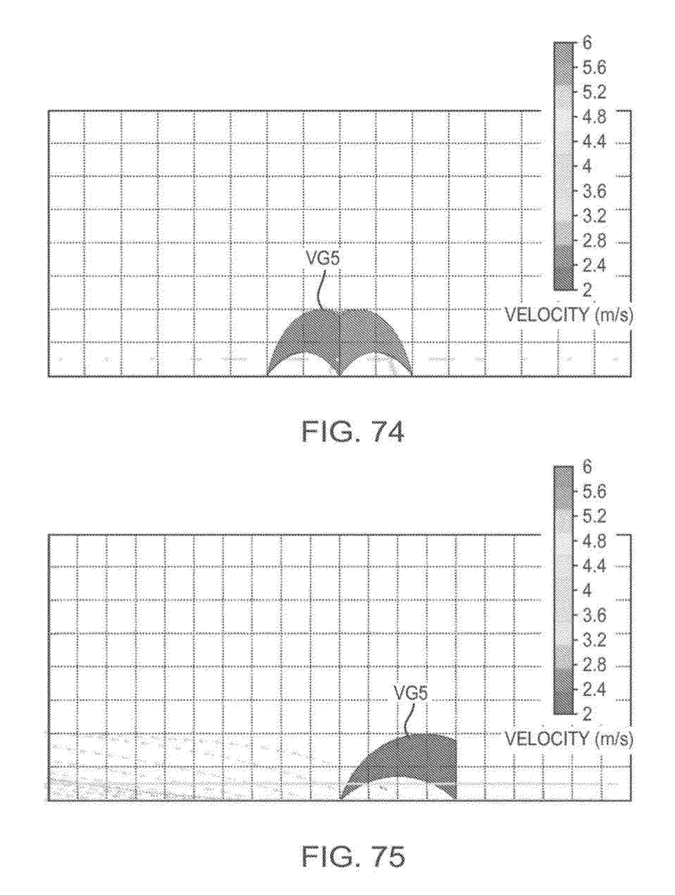

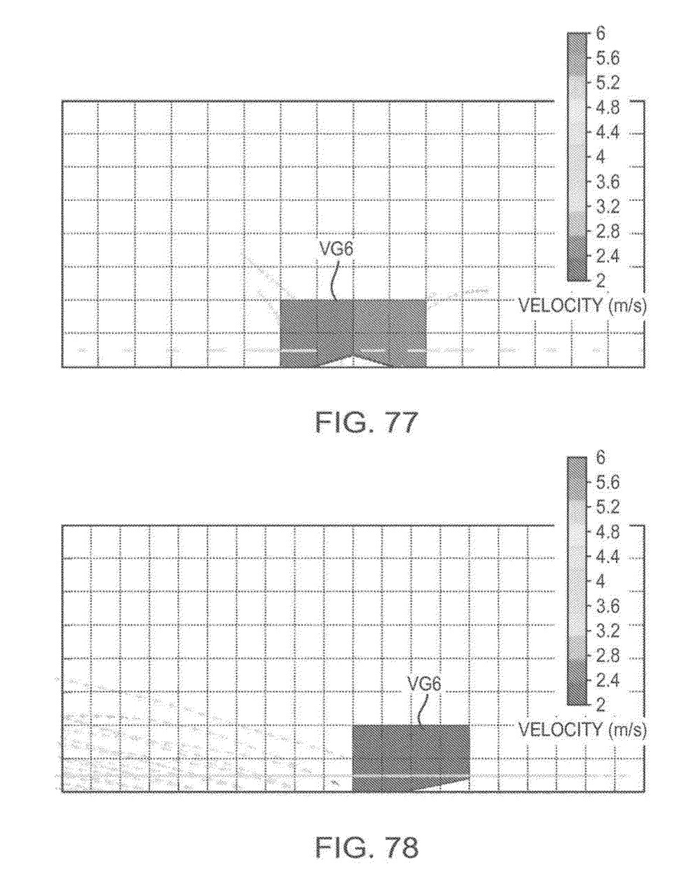

Initial studies of the vortex generator concept simulated flow around vortex generator shapes to understand the effects of feature changes. All vortex generators tested had the same major dimensions of maximum height (20 mm), part length (40 mm), and width (40 mm), as shown in FIG. 38. Six different vortex generator shapes were tested and are referred to in the text according to their shape designation number as shown in FIG. 39. Each of these vortex generator shapes is an embodiment of vortex generator 26, described above. The first design VG1 is the simplest of the vortex generator shapes with a straight extrusion of a V-shaped two-dimensional sketch. The second version of the vortex generator part VG2 is an extrusion of the V-shape having the same frontal height as VG1 but with the upper surface tapering linearly toward the rear points of the part. VG3 is a version of VG1 but with the upper surface being curved concave down as show in the third row of the table. VG4 is a modification of VG1 with a taper to the rear points, as with VG2, but in this case the taper begins normal to the front edge of the part forms a rounded upper edge. The design of VG5 further modifies VG4 by introducing curved gaps between the surface plane and the legs of the V-shaped part on either side. Finally, VG6 is an iteration of VG1 but with an opening at the front of the vortex generator between the surface plane and the frontal edge of the part. Isometric views of flow are shown in the second and third columns of Table 7.2 and larger images of flow around the shapes are shown in FIGS. 61-78 and discussed in the section entitled “Additional Simulation Results.”

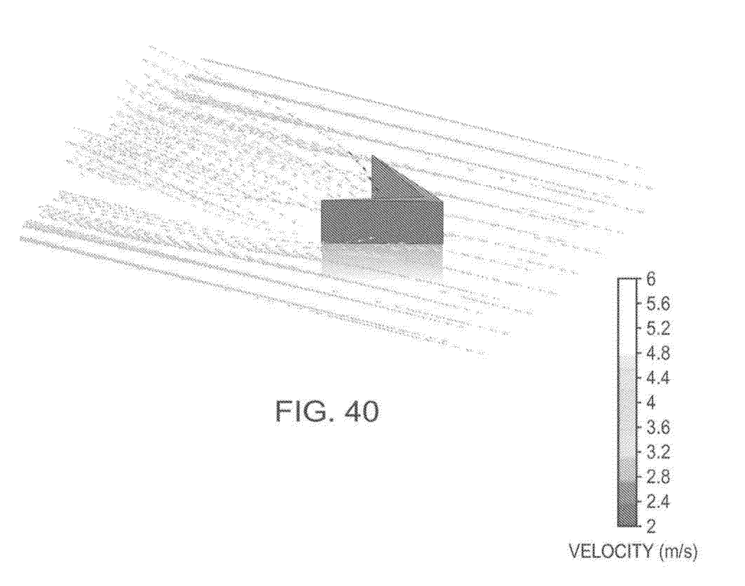

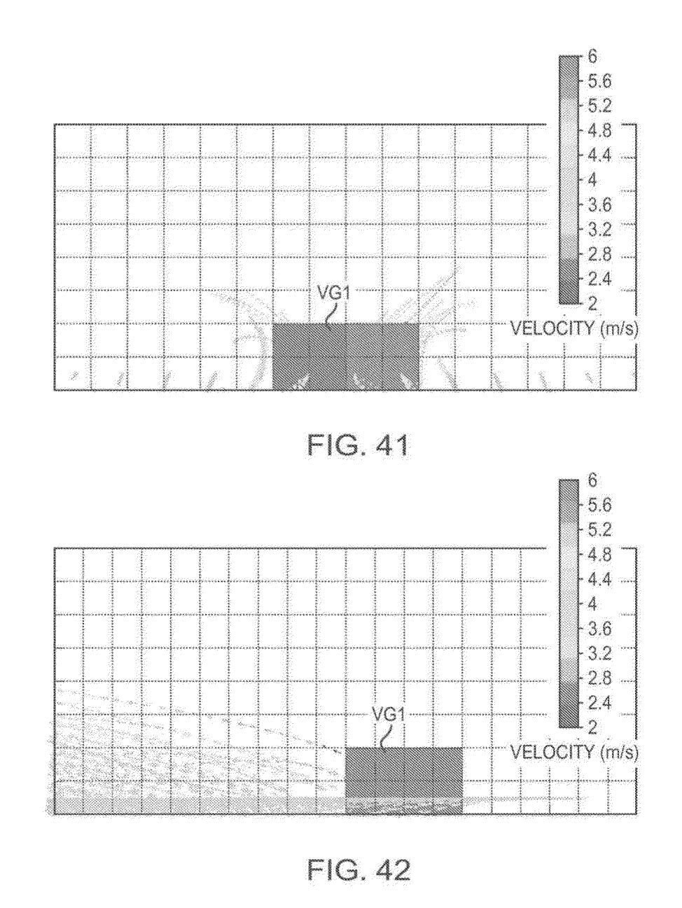

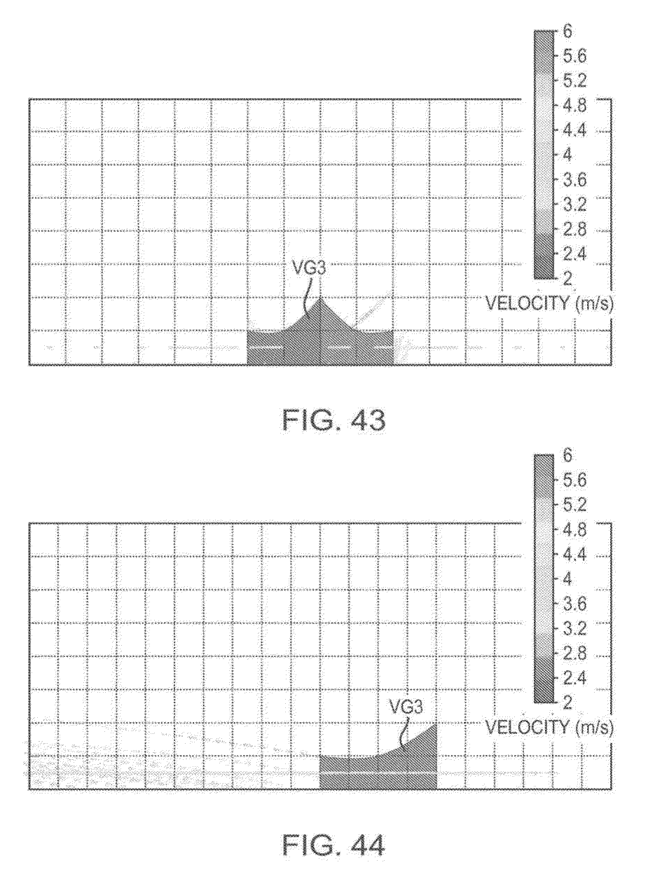

Flow simulations for air at speeds of 5 m/s were conducted for a volume 80 mm from the bottom of the vortex generator shape, 200 mm in depth starting 60 mm ahead of the front edge and extending 140 mm back, and 160 mm in width for the part. Larger simulation volumes greatly increased the simulation processing times. Flow was simulated approaching parallel to the bottom plane of the vortex generator with flow approaching the front edge of the V-shaped extrusion before flowing around the legs of the shape. An isometric view of a flow simulation iteration for VG1 is shown in FIG. 40. This image shows vectors representing flow direction and speed passing around the structure, with upward flow directionality behind the shape. For other versions of the vortex generator, isometric views tended to make relative comparisons difficult to visualize. To visually compare the performance of the six designs, front and side view comparisons of a vector field originating 1 mm from the bottom of the surface plate were compared in terms of horizontal spread and height change in a plane located 140 mm front edge whose normal is parallel to the original flow direction. FIG. 41 and FIG. 42 show front and side views of VG1 with air flow at 5 m/s with a 10 mm grid spacing overlay. FIG. 43 and FIG. 44 show front and side views of flow around one of the weaker designs (VG3) in terms of lift height. In addition to the height and spread of the flow around the part, a maximum velocity in the fluid field was identified for each design. Table 7.3 gives a summary of flow height and width in the 140 mm offset plane as well as the maximum velocity.

TABLE 7.3
Vortex generator performance measures and results for
six design iterations at 5 m/s in air.

| Vortex | Maximum | Flow Height | Flow Width |
|---|---|---|---|
| Generator | Velocity (m/s) | (mm) | (mm) |
| VG1 | 6.15 | 38 | 37 |
| VG2 | 5.90 | 22 | 18 |
| VG3 | 5.78 | 21 | 25 |
| VG4 | 6.08 | 30 | 30 |
| VG5 | 5.95 | 20 | 20 |
| VG6 | 6.13 | 34 | 31 |

Results from the flow simulation study show maximum velocities greatest for the VG1 design at 6.15 m/s followed by VG6 with 6.13 m/s. The design with the smallest maximum velocity measurement was VG3 at 5.78 m/s. For the height change comparison of flows initiating 1 mm from the surface and measured 140 mm behind the vortex generator, VG1 had the maximum lift at 38 mm followed by VG6 with 34 mm. The heights for VG2, VG3 and VG5 were significantly lower, at 22 mm, 21 mm and 20 mm respectively. As measured from the center-plane horizontally in one direction, the flow width for VG1 was 37 mm followed by VG6 with 31 mm. The lowest observed width for the flow spread was VG2 with 18 mm. The same simulations, when assuming an air flow of 2 m/s showed the same relative performance for the shapes, but with smaller magnitudes.

From the initial evaluation of the vortex generator shapes described, the simplest vortex generator shape, VG1 performed better than the other five designs in all three evaluation categories. This design was chosen for further comparison and visualization for vortex generator and cleaning capability.

To scale features of the simulation for further studies of vortex generator performance, Reynold's number scaling was used to estimate the relative performance for flow in water as well as for the full size trough. Table 7.4 shows the Reynold's numbers of a vortex generator when scaled for air at the actual scale of the full-sized parabolic trough for three wind speeds, as well as the Reynold's numbers for the simulated wind speeds and dimensions of the modeled part, and finally, that of the vortex generator when tested in a water tunnel for particle imaging velocimetry studies. In some cases, both the wind speed and characteristic length of the vortex generator may be set. Limitations of the pump speed of the water tunnel to 0.1 m/s as well as the test section allowed only the variation in vortex generator scale to be set. Details of the water tunnel test setup and results are given in the next section (Water Tunnel Testing of Vortex Generators).

The Reynold's numbers given for the design scenarios in the case of the air at actual scale can be varied by assuming a different scaling of the vortex generator depending on the wind speed that is specified as the target operational speed. However, the target wind speed depends on assumed parabolic trough installation location as well as the desired performance of the vortex generator. The lower limit of operational wind speed is preferably set based on the minimum operational wind speeds that occur in a given region with sufficient frequency to maintain a cleaning schedule. The upper limit target cleaning speed is preferably set based on some percentage of the maximum operational wind speed set for the troughs. In addition to the target wind speed, the dimensions of the vortex generator may be adjusted to scale with simulations. Results of the water tunnel and simulation studies can be scaled to full size according to the Reynold's number ratio mentioned to achieve the same baseline results. In both scaling cases, the dimensions of the resulting vortex generator may still be on the order of centimeters, which is within an acceptable range of dimensions to mount to the trough structure. The final desired Reynold's number and scaling may to be determined on a larger scale panel to optimize the size and spacing, in accordance with the optimization outline provided by the previous test.

### Water Tunnel Testing of Vortex Generators

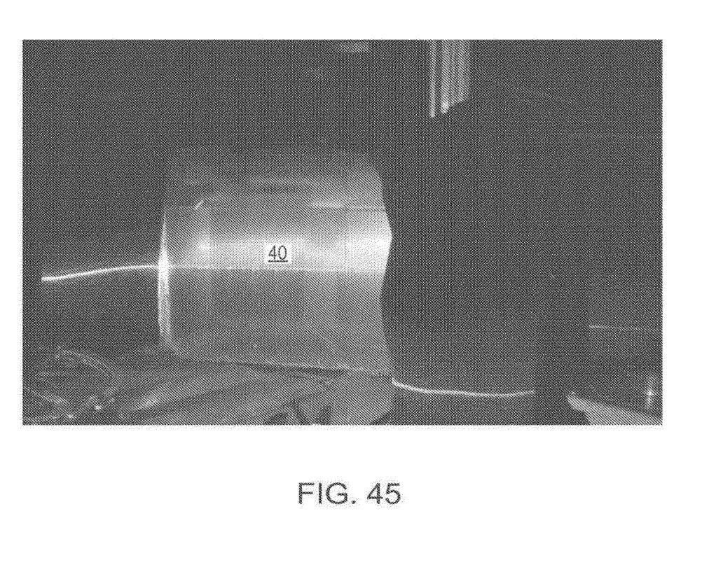

To visualize the vortex shedding off the vortex generator concept VG1, particle imaging velocimetry was used to capture flow patterns behind an extrusion with 30 degree, 45 degree, and 60 degree V-shapes. To capture the dynamic effects of a vortex generator in a fluid field, a water tunnel 40 with 200 mm×200 mm cross-sectional area, 10 cm/sec nominal flow rate and seeded with 50 micron glass beads was used to image the flow. A green laser was used to image a horizontal flow plane, creating a two dimensional image of particle motion, which was captured using a rear mounted camera with 40 fps frame rate. An image of the water tunnel with PIV testing in progress is shown in FIG. 45.

TABLE 7.4
Reynold's number of vortex generator features in air for low, medium, and
high wind speeds, as well as for fluid flow simulation parameters and water tunnel parameters.

| | | air actual | air actual | air actual | air | air | water |
|---|---|---|---|---|---|---|---|
| | units | scale (low) | scale (med) | scale (high) | simulation | simulation | tunnel |
| density (rho) | kg/m \hat{ } 3 | 1.18 | 1.18 | 1.18 | 1.18 | 1.18 | 997 |
| velocity | m/s | 3 | 6 | 10 | 2 | 5 | 0.1 |
| characteristic | m | 0.067 | 0.04 | 0.02 | 0.04 | 0.04 | 0.04 |
| dimension (fin length) | | | | | | | |
| mu | Pa * s | 1.80E−05 | 1.80E−05 | 1.80E−05 | 1.80E−05 | 1.80E−05 | 8.94E−04 |
| mu/rho | | 1.5254E−05 | 1.5254E−05 | 1.5254E−05 | 1.5254E−05 | 1.5254E−05 | 8.97E−07 |
| Reynolds Number | | 1.32E+04 | 1.57E+04 | 1.31E+04 | 5.24E+03 | 1.31E+04 | 4.46E+03 |
| Reynolds number ratio | | 1.01 | 1.20 | 1.00 | 0.40 | 1.00 | 0.34 |
| wrt air at 10 m/s | | | | | | | |

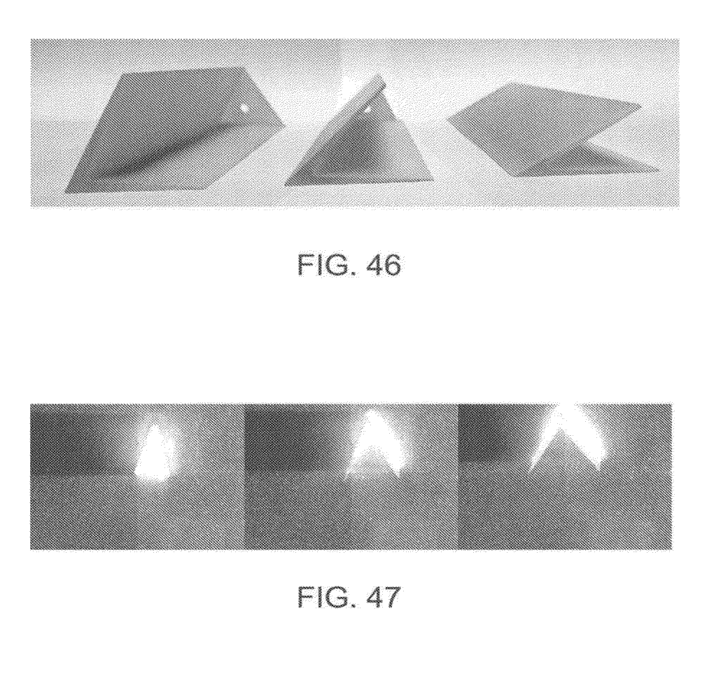

Models of the vortex generator shapes were produced using stereolithographed parts of DSM Somos 18420 resin with a glass bean finish to achieve a smooth planar part, while maintaining a sharp front edge Parts were extruded to 200 mm length to ensure that the imaging plane would be far from edge effects. Models were prepared by Vaupell Rapid Prototyping Stereolithography resin. http://www.vaupell.com/stereolithography-sla. The three resulting extruded vortex generator parts are shown in FIG. 46.

Results of the flow visualization were captured as image sequences of particle position in the laser imaging plane. FIG. 47 shows a raw image of particle flow for each of the three angled vortex generators. Particle image velocimetry software PIVView was used to process sets of sequential images. By comparing particle position in the images along with frame rate and vortex generator dimensions in the plane, vector fields were created for each part configuration. Images used for flow analysis have the vortex generator positioned largely out of the image frame in the upper right corner to allow for maximum trailing flow length in the image. Shadowing of the part in the images is responsible for discrepancies in vector calculations in the upper left section of the images. All images were post-processed to remove a single horizontal pixel line defect in the image, which interfered with vector flow analysis.

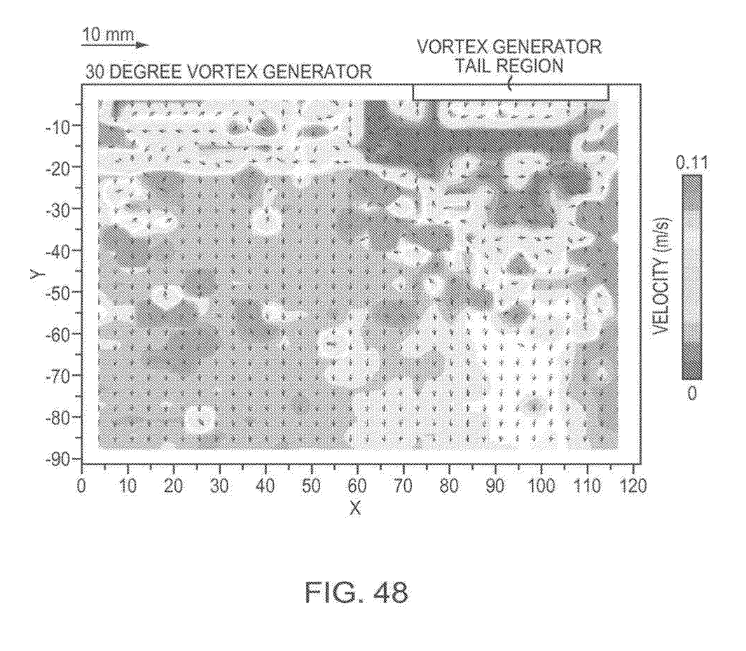

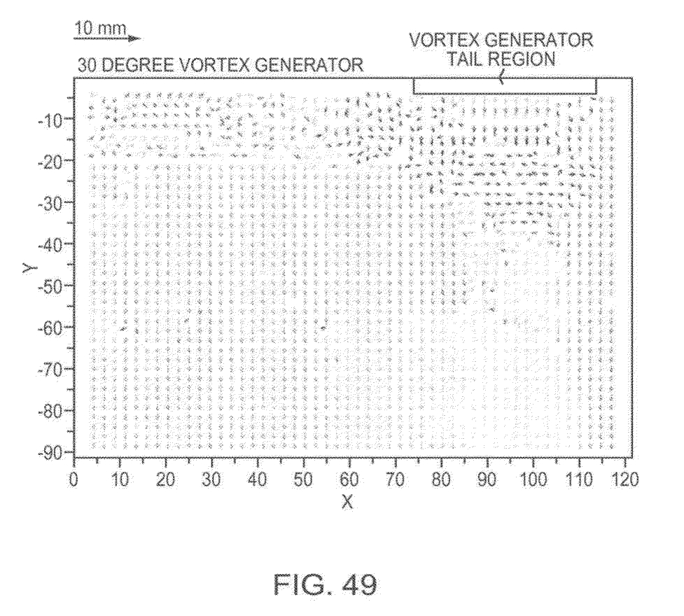

Results of the 30 degree vortex generator are shown in FIG. 48, with the tail region of the vortex generator marked in the upper right. The velocity map, with flow starting at the upper edge of the plot and flowing down, shows the affected region behind the vortex generator approximately 80 mm, twice the tail width and more than twice the vortex generator length at 90 mm. Velocity of the unaffected flow on the left hand side of the plot show approximate 10 cm/s flow rate, whereas behind the vortex generator, flow rates range from 0 m/s to 0.11 m/s. FIG. 49 shows a vector plot of the same 30 degree data, but which allows for clearer viewing of the vector directionality. In this plot, the increased turbulence of the flow behind the vortex generator is visible when compared to vector fields in the free flow region on the left. The same shadowing error vectors in the upper left (20 mm×60 mm) should be ignored, as they are a result of image processing and were not visible in actual particle flow.

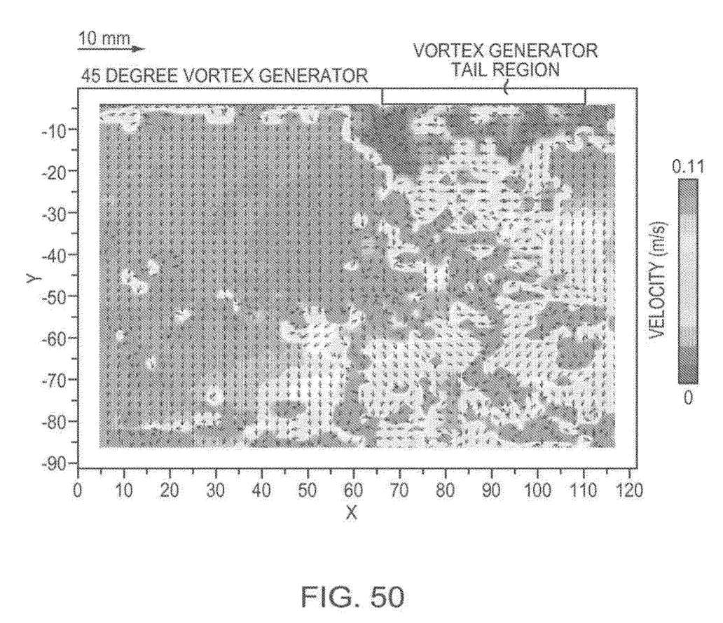

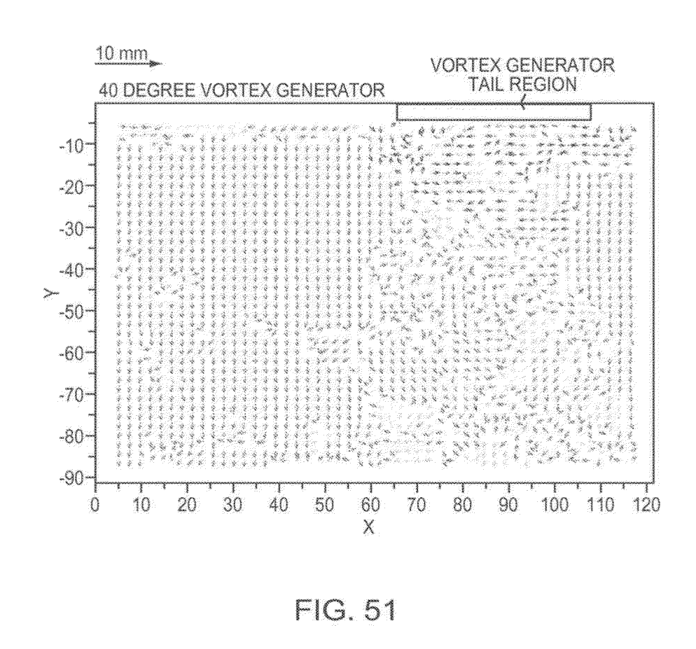

PIV analysis was conducted with the same testing parameters for a 45 degree vortex generator shape. FIG. 50 shows the resulting vector field and velocity map for the 45 degree shape, with the tail region labeled in magenta in the upper right corner of the plot. In the case of the 45 degree vortex generator, the affected zone for the same nominal 0.1 m/s flow rate shows a much larger affected area extending approximately 90 mm in width at the extent of the 90 mm travel length. Velocity behind the vortex generator ranges from 0 m/s to 0.11 m/s or greater. In the 45 degree case, FIG. 51 shows a larger zone of turbulent flow that for the 30 degree shape, more eddies are visible and a wider overall affected zone is visible compared to that of the 30 degree shape in FIG. 49.

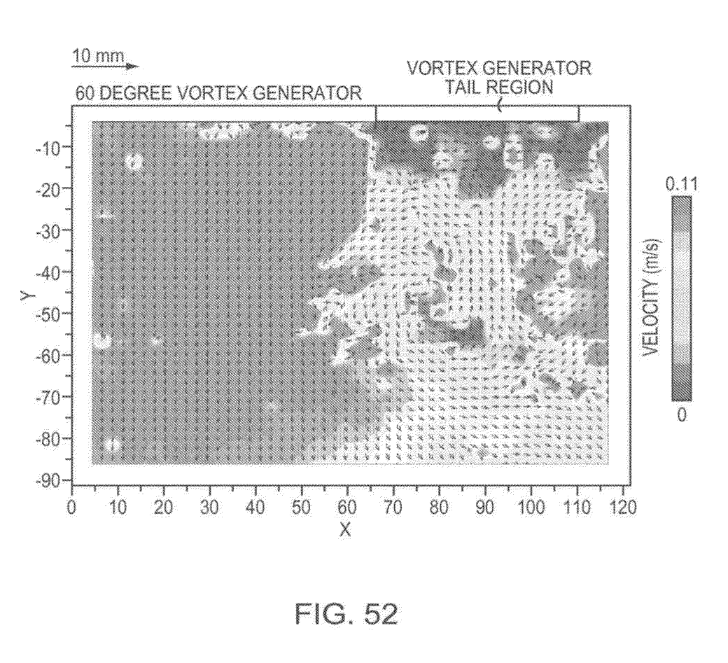

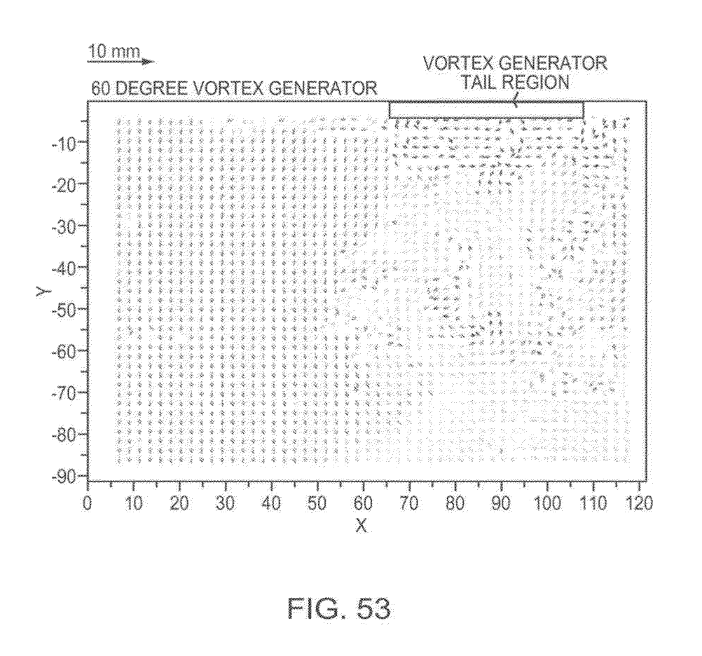

The 60 degree vortex generator shape, with velocity field and vector plot shown in FIG. 52 shows a similarly sized flow field as for the 45 degree vortex generator. In this case fewer but larger vortices appear in the image, and the overage velocity in the turbulent region appears more uniform in the 0.5 m/s range. FIG. 53 showing the vector field for the 60 degree part shows a similarly 70 mm-80 mm wide turbulent region behind the vortex generator.

Results from the vortex generator angle variation and PIV imaging show larger turbulent regions for 45 degree and 60 degree vortex generator shapes than for a 30 degree shape. Between the 45 degree and 60 degree versions of the part, the 45 degree part shows a higher average velocity behind the tail of the vortex generator.

### Reflectance Measurement of Vortex Generator Cleaning on a Mirror Film Surface

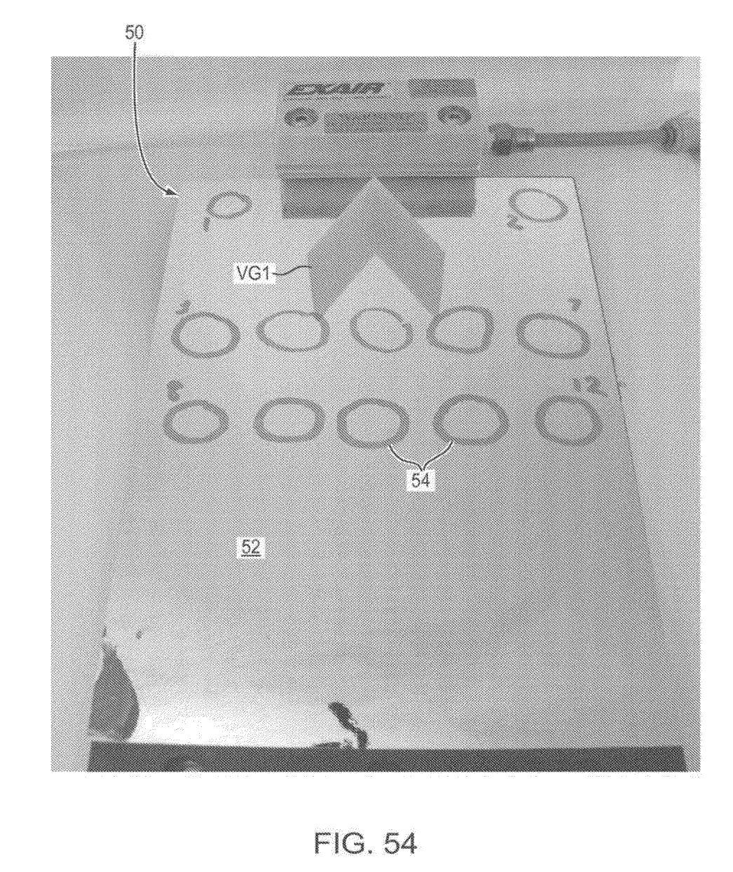

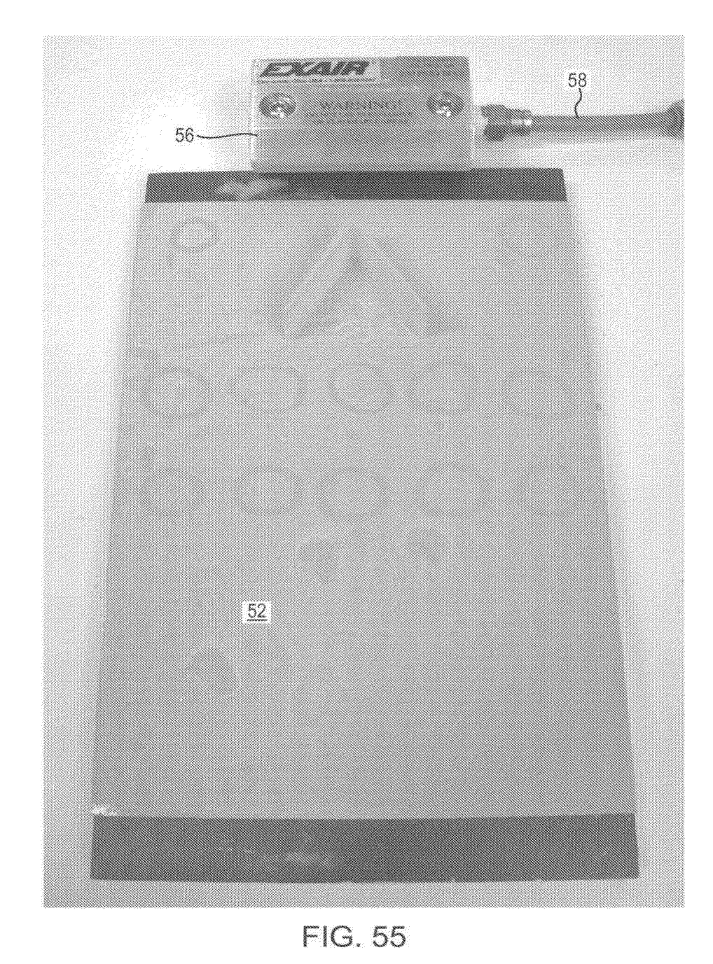

Ultimately the vortex generator cleaning concept may increase the efficiency of a parabolic trough collector panel more effectively than existing flow alone. To test the concept effectiveness, a bench-top test of reflectance was performed on a test panel 50 that included a 150 mm×180 mm galvanized steel sheet with mirror film applied to the front-side surface 52. A 40 mm×40 mm×20 mm vortex generator VG1 shape, as detailed in FIG. 38, was stereolithographed and attached to the center-line of the sample panel as shown in FIG. 54 with reflectance testing locations 54 shown circled. Twelve sample locations were tested round the vortex generator shape, with Location 1 and Location 2 in left and right front corners of the test part, where it was assumed that little effect would be seen. A test row 20 mm behind the vortex generator in five locations centered about the flow axis and space approximately 30 mm apart were used for Location 3 through Location 7 from left to right. Another 30 mm behind the first test row, Locations 8-12 were labeled from left to right on the sample. Initial measurements of the clean surface reflectance were taken with a Stellarnet Blue Wave Spectrometer for wavelengths of 350-1100 nm. To produce a uniform layer of contamination over the surface, the mirror panel with attached vortex generator was placed in a dust chamber for 23 minutes with Arizona Medium Test Dust Measurements of reflectance over the contaminated surface were taken in several locations. See Figuerdo, S., Parabolic Trough Solar Collectors: Design for Increasing Efficiency, thesis, Massachusetts Institute of Technology (2011), sections 6.2.1 and 6.4, incorporated herein by reference in its entirety. FIG. 55 shows the panel surface 52 with uniform deposition across the surface.

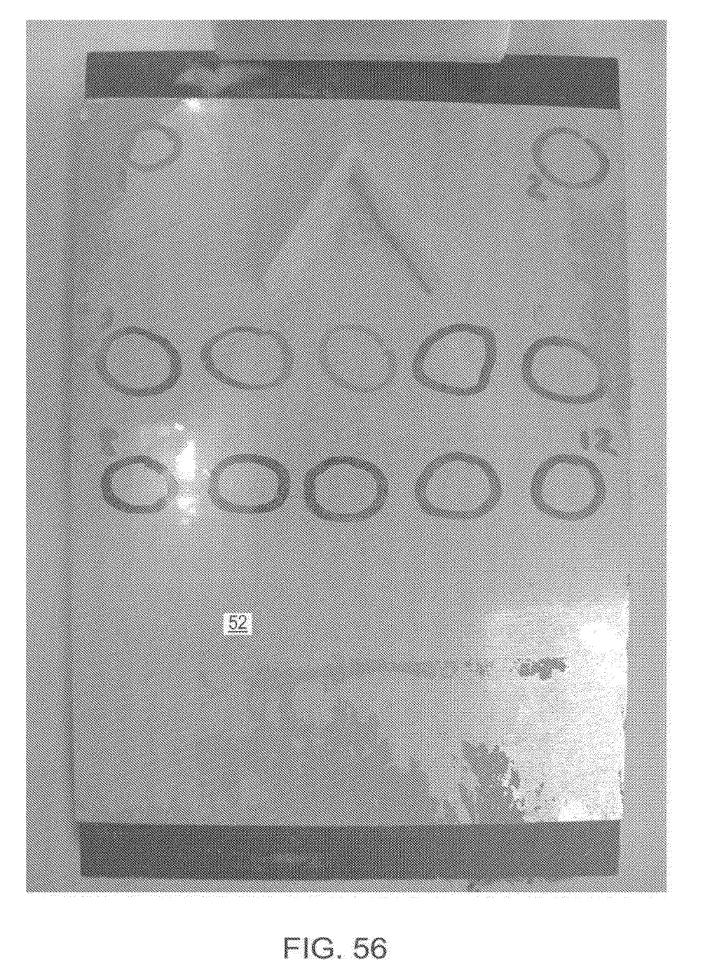

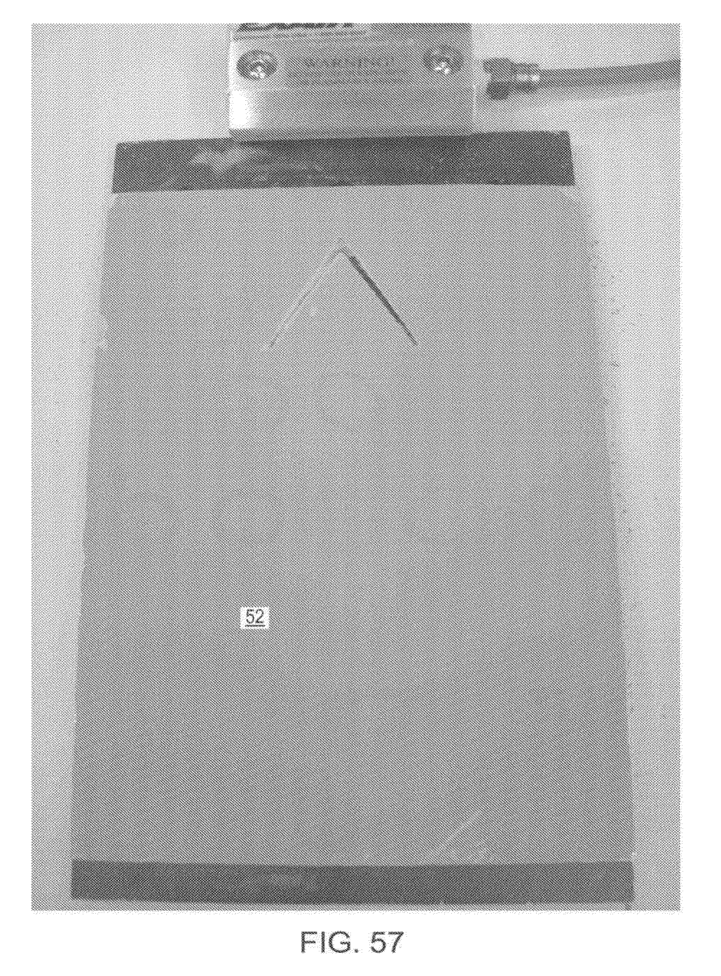

To create a uniform sheet of air flowing over the panel an Exair air knife 56 was placed 30 mm in front of the vortex generator edge with the flow plane offset approximately 5 mm from the surface. A constant pressure air supply 58 of 290 kPa (28 psi) was used to flow air at a measured speed of 5.9 m/s at the exit of the device. Measurements of reflectance after air flow were taken over the Locations 1-12. FIG. 56 shows the resulting panel surface 52 after a 60 second cleaning, after which little visible change was observed.

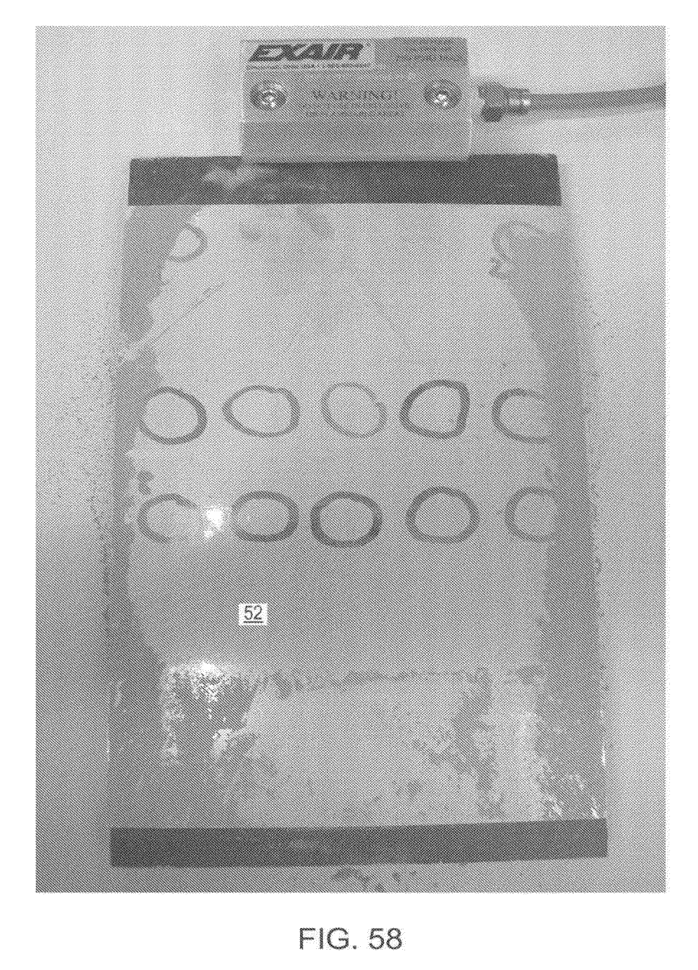

Following the vortex generator tests the panel surface 52 was deposited with dust for a second 23 minutes and the vortex generator was removed from the surface. FIG. 57 shows the deposited panel surface 52 prior to cleaning. Surface cleaning with the same flow rate and flow offset was repeated on the untreated surface. The resulting cleaned surface 52 without a vortex generator is shown in FIG. 58.

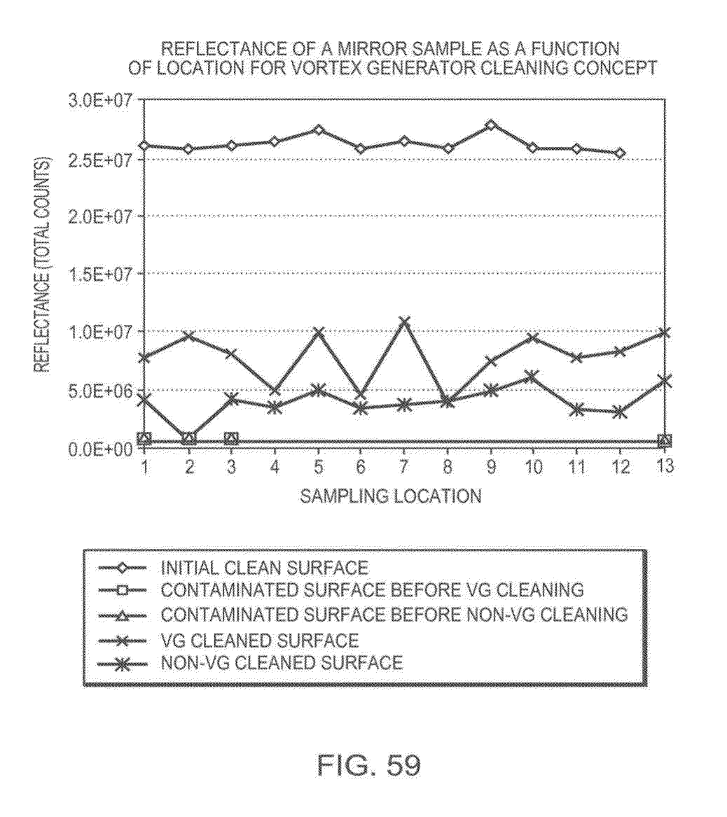

Results of the reflectance measurements over the sample surface are shown in FIG. 59. In this plot, the total reflectance of the clean surface over all locations averages 2.5×10⁷ counts when assessing the raw intensity data. The contaminated surface, both before vortex generator cleaning and for simple air flow over the surface, had approximately 0.5×10⁶ counts. For the surface after cleaning using a simple airstream over the surface, total reflectance averages 3.9×10⁶ counts and for the surface cleaned air flow around the vortex generator shape total reflectance averages 7.4×10⁶ counts. In this plot additional reflectance measurements are shown as Location 13, which was at the very end center of the panel. This additional measurement was taken for the contaminated surfaces when it was found that placement of the reflectance probe in Location 3 to Location 12 may potentially disturb the deposited dust layer of adjacent test locations.

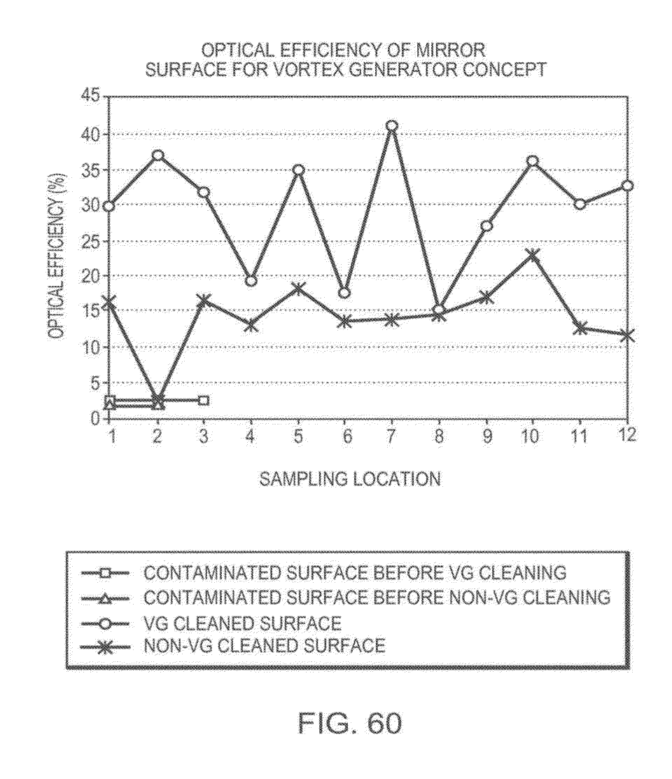

FIG. 60 shows the efficiency of the cleaned surfaces according to location, compared to the total reflectance of the initial uncontaminated surface. In this plot, optical efficiency of the panel after air flow over the surface with no vortex generator present varied from 1.8% to 23% with an average efficiency of 14.4%. For the panel performance after cleaning with the vortex generator located on the surface, the efficiency ranged from 15.0% to 41.1% with an average of 29.3% efficiency. Where measurements were made for the contaminated surfaces, optical efficiency was measured at 1.8%-2.5%.

This difference in cleaning performance shows that vortex generators improve surface cleanliness of mirror film panels.

Additional Flow Simulation Results

In addition to the images discussed above, images of flow for all six vortex generator shapes are shown for flow at 5 m/s in air.

Flow Simulations for Six Vortex Generator Profiles

In order to evaluate the relative flow length and vertical lift resulting from vortex generator shapes, six concepts with the same maximum part height, length and width, as well as V-angle were simulated in the SolidWorks flow simulation package. Flow simulation parameters are for air at 5 m/s. Overall part height is 20 mm, part width is 40 mm, and length is 40 mm. See above for additional simulation details. In the front and side views, a grid with 20 mm spacing allows for comparison with the other designs for flow height and spread. The scale of the flow velocity shown in the upper right of the images is consistent between all views and between all shapes.

VG1: Vortex generator one is the simplest shape of the vortex generators, with a purely extruded part shape that is orthogonal to the desired cleaning surface. FIG. 61 to FIG. 63 show the flow in isometric, front and side perspectives.

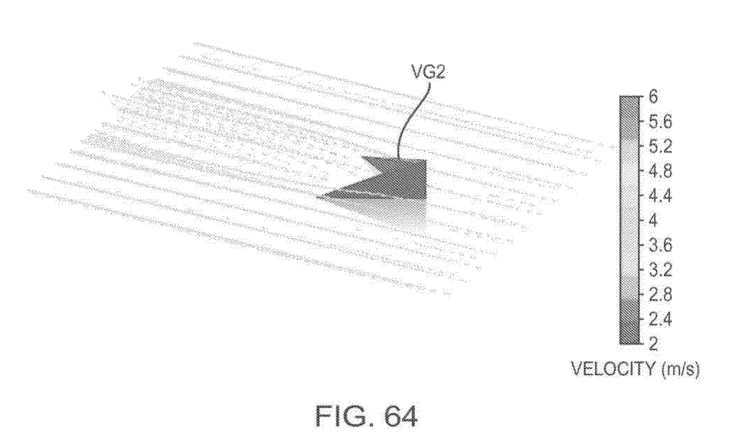

VG2: Vortex generator two is the equivalent to shape one except with a linear slope from the front edge down to the rear points of the shape. FIG. 64 to FIG. 66 show this shape in more detail, with the flow around the form.

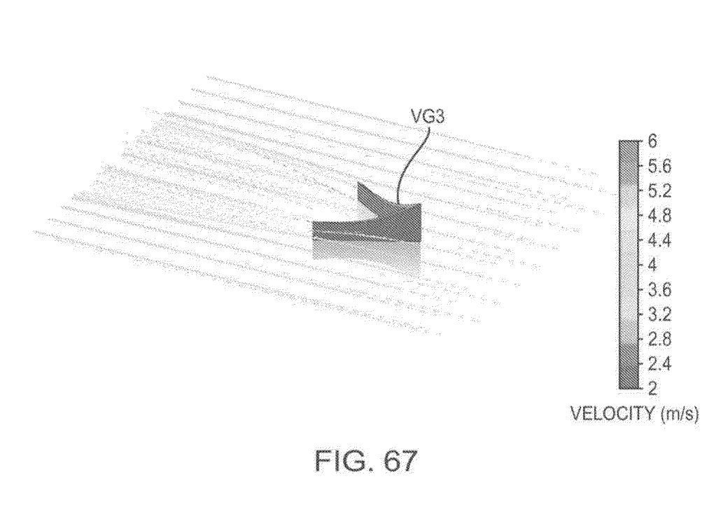

VG3: Vortex generator three is the equivalent to shape one except with an inner curved slope from the front edge down to the rear points of the shape. FIG. 67 to FIG. 69 show this shape in more detail, with the flow around the form.

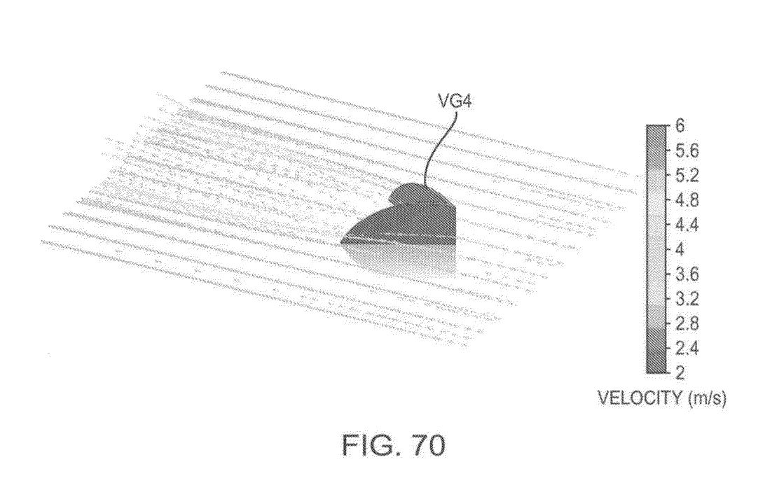

VG4: Vortex generator four is the equivalent to shape one except with an outer convex slope from the front edge down to the rear points of the shape. FIG. 70 to FIG. 72 show this shape in more detail, with the flow around the form.

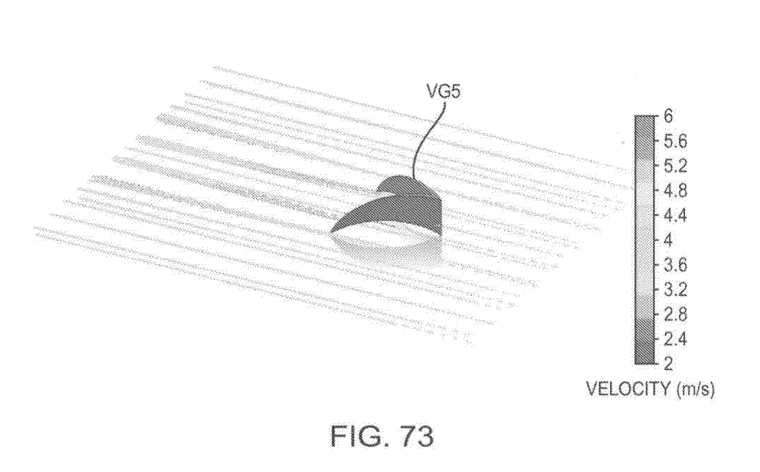

VG5: Vortex generator five is the equivalent to shape four with an outer convex slope from the front edge down to the rear points of the shape, with the addition of a curved section removed from the lower fin area. FIG. 73 to FIG. 75 show this shape in more detail, with the flow around the form.

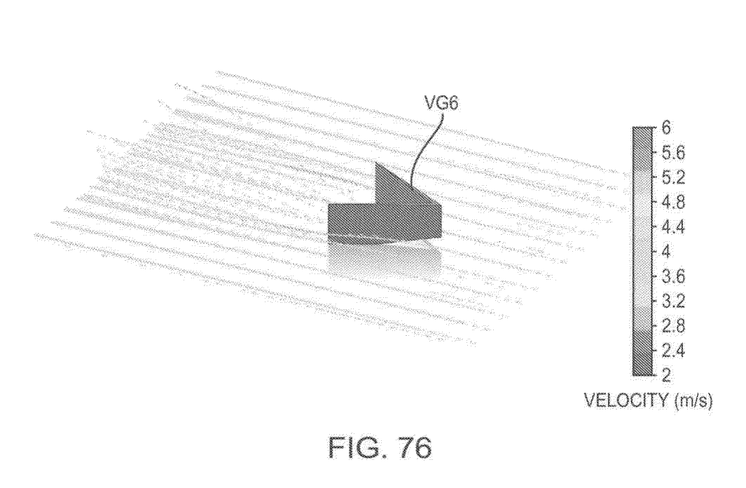

VG6: Vortex generator six is the equivalent to shape one with extruded bulk form, except with a straight section removed from the front of the lower fin area. FIG. 76 to FIG. 78 show this shape in more detail, with the flow around the form.

In view of the simulation, visualization and small scale panel test of vortex generator cleaning performance, use of this passive cleaning method may result in cleaning savings over the lifetime of a solar plant.

Further modifications of the invention will also occur to persons skilled in the art, and all such are deemed to fall within the spirit and scope of the invention as defined by the appended claims.

What is claimed is:

1. A solar panel configured to reduce contaminant accumulation thereon, the solar panel comprising:
a surface adapted to harvest solar energy; and
a vortex-inducing generator comprising a plurality of chevron-shaped features disposed across at least a portion of the surface to reduce contaminant accumulation thereon by at least one of (i) causing air flow passing over the surface to remove at least some contaminants deposited thereon; and (ii) keeping particles entrained in the air flow to reduce deposition on the surface.

2. The solar panel of claim 1, wherein the surface comprises a parabolic-shaped trough.

3. The solar panel of claim 1, wherein the vortex-inducing generator comprises a material selected from the group consisting of UV-resistant polymer, metal, glass, and a composite.

4. The solar panel of claim 1, wherein at least one chevron-shaped feature defines an included angle selected from a range of about 30 degrees to about 120 degrees.

5. The solar panel of claim 1, wherein at least one chevron-shaped feature defines an opening having a maximum width equal to a, and the chevron-shaped features are disposed on the solar panel surface at a pitch selected from a range of about 1.5a to about 5a.

6. The solar panel of claim 1, wherein at least one chevron-shaped feature defines an opening having a maximum width equal to a, and a maximum height of 2a.

7. The solar panel of claim 1, wherein at least one chevron-shaped feature comprises a constant height.

8. The solar panel of claim 1, wherein at least one chevron-shaped feature comprises a varying linear height.

9. The solar panel of claim 1, wherein at least one chevron-shaped feature comprises a varying nonlinear height.

10. The solar panel of claim 1, wherein each chevron-shaped feature forms a gap with the surface along at least a portion thereof.

11. The solar panel of claim 1, wherein each chevron-shaped feature is oriented at an angle selected from a range of ±45° relative to an edge of the surface.

12. The solar panel of claim 1, wherein the surface defines a plurality of openings.

13. The solar panel of claim 1, further comprising a supporting structure for the surface.

14. A method of passively cleaning a solar panel, the method comprising the steps of:
providing the solar panel comprising:
a surface adapted to redirect solar energy; and
a vortex-inducing generator comprising a plurality of chevron-shaped features disposed across at least a portion of the surface proximate a leading edge to reduce contaminant accumulation thereon by at least one of (i) causing air flow passing over the surface to remove at least some contaminants deposited thereon; and (ii) keeping particles entrained in the air flow to reduce deposition on the surface,
positioning the solar panel such that the leading edge is oriented to intercept a prevailing wind direction.

15. The method of claim 14, wherein the positioning step comprises:
measuring at least one of a wind velocity and a vibration of the panel; and
actuating a panel positioning system to position the panel to a previously known best position for a given wind velocity.

16. The method of claim 14, further comprising the step of providing a supporting structure for the surface.

17. The method of claim 16, wherein the supporting structure is adapted to move the surface.

18. The method of claim 17, wherein the surface is moved to at least one of track the solar energy and intercept a changed wind direction.

19. A solar array comprising:
a plurality of solar panels, each solar panel comprising:
a surface adapted to redirect solar energy; and
a vortex-inducing generator comprising a plurality of chevron-shaped features disposed across at least a portion of the surface proximate the leading edge to reduce contaminant accumulation thereon by at least one of (i) causing air flow passing over the surface to remove at least some contaminants deposited thereon; and (ii) keeping particles entrained in the air flow to reduce deposition on the surface,
wherein each solar panel is positioned such that the leading edge is oriented to intercept a prevailing wind direction.
